(19) United States
(12) Patent Application Publication
(10) Pub. No.: US 2010/0099830 A1
(43) Pub. Date: Apr. 22, 2010

(54) RESIN COMPOSITION, METHOD FOR PRODUCING THEREOF, AND COPOLYMER

(75) Inventors: Tomohide Yoshida, Mie (JP); Katsushi Yamaoka, Mie (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: MITSUBISHI CHEMICAL CORPORATION, Minato-ku (JP)

(21) Appl. No.: 12/523,617

(22) PCT Filed: Jan. 16, 2008
(86) PCT No.: PCT/JP08/50459

§ 371 Date: Sep. 14, 2009

(30) Foreign Application Priority Data
Jan. 17, 2007 (JP) 2007-008349
Mar. 28, 2007 (JP) 2007-085801

(51) Int. Cl. C08L 67/04; C08G 63/664

(52) U.S. Cl. 525/450; 528/301

(57) ABSTRACT

In order to provide a resin composition with a well-balanced properties such as thermal resistance, moldability, flexibility and others through the use of a polyhydroxycarboxylic-acid-based resin, the resin composition contains at least a polyhydroxycarboxylic-acid-based resin comprising a structural unit represented by Formula (1) as a main structural unit; and a polyoxytrimethyleneglycol-based resin comprising a structural unit represented by Formula (2) as a main structural unit

—R¹—COO— (1)

(where, R¹ in Formula (1) represents a divalent aliphatic hydrocarbon group)

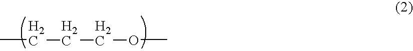

### TECHNICAL FIELD

The present invention relates to a novel resin composition containing a polyhydroxycarboxylic-acid-based resin and a production method thereof, and a novel copolymer containing a polyhydroxycarboxylic-acid-based block.

Throughout the present invention, a “resin composition” means a composition containing one or more kinds of resin as the main component. Here, the main component of a composition is a component the content of which is 30 wt % or more of the composition.

### BACKGROUND TECHNIQUE

Polyhydroxycarboxylic acid represented by polyglycolic-acid and polylactic-acid is synthesized from natural material such as plants (corn or others). Compared to aliphatic polyester, because of the superior properties such as thermal resistance, biodegradability, transparency, melting moldability, tenacity, rigidity and others, various applications of polyhydroxycarboxylic acid are being contemplated.

However, polyglycolic-acid and polylactic-acid are low in flexibility, are hard and brittle, and additionally are insufficient in moldability, so that industrial applications thereof are actually limited.

For the above, for example, in order to improve the flexibility of the polylactic-acid, there are an attempt to copolymerize a monomer such as lactic-acid lactide with another resin (see Patent Reference 1) and attempts to mix or copolymerize polylactic-acid with another resin (see

Patent References 2-5). As a resin to be mixed or copolymerized with polylactic-acid or a resin to be copolymerized with a monomer such as lactic-acid lactide, polyethylene glycol (PEG) has been mainly used.
[Patent Reference 1] Japanese Patent No. 3501249
[Patent Reference 2] Japanese Patent No. 3391133
[Patent Reference 3] Japanese Patent Application Laid-Open No. HEI 1-163135
[Patent Reference 4] Japanese Patent Application Laid-Open No. 2004-231773
[Patent Reference 5] Japanese Patent Application Laid-Open No. 2004-250698

### DISCLOSURE OF INVENTION

### Problems to be Solved by Invention

However, in the method described in Patent Reference 1 using lactic-acid lactide as a material to be copolymerized with a resin such as PEG, the usage of lactic-acid lactide which easily sublimes problematically makes the production process extremely complicated.

Further, methods described in Patent References 2-5 using polylactic-acid as a material have easy production processes but obtain resins low in molecular weight, which therefore requires increase in molecular weight for practical usage. However, these resins cannot be solid-phase polymerized, and the molecular weights thereof are difficult to be increased through melting polymerization.

Further, the above conventional techniques do not obtain a resin which does not impair properties superior in thermal resistance and others inheritance from polyhydroxycarboxylic-acid exemplified by polyglycolic-acid and polylactic-acid and which additionally possess sufficiently improved properties of moldability, flexibility and others.

With the foregoing problems in view, the present invention is conceived. Namely, the object of the present invention is to provide a resin composition which contains a polyhydroxycarboxylic-acid-based resin and which has well-balanced properties such as thermal resistance, moldability, flexibility and others and provide the production method thereof.

### Means to Solve the Problems

As the result of earnest study to solve the above problems, inventors of the present invention have found that a resin composition, obtained through mixing a polyhydroxycarboxylic-acid-based resin such as polyglycolic-acid and polylactic-acid or a cyclic ester compound thereof such as lactic-acid lactide that can serve as the material of the resin, and a polyoxytrimethylene-glycol(hereinafter sometimes called “PO3G”)-based resin both in the melting states, is superior in moldability and flexibility. Further, Inventors also have found that mixing of the resin composition and a polyhydroxycarboxylic-acid-based resin further improves the properties such as thermal resistance, and have completed the present invention.

Specifically, an aspect of the present invention relates to a resin composition containing: at least a polyhydroxycarboxylic-acid-based resin (A) comprising a structural unit represented by Formula (1) as a main structural unit; and a polyoxytrimethyleneglycol-based resin (B) comprising a structural unit represented by Formula (2) as a main structural unit (claim 1)

[Formula 1]

—R¹—COO— (1)

(where, R¹ in Formula (1) represents a divalent aliphatic hydrocarbon group).

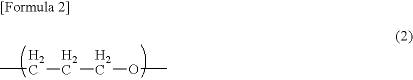

In this aspect, the number-average molecular weight of the polyoxytrimethyleneglycol-based resin (B) is preferably 400 or more, and 500,000 or less (claim 2).

In addition, the structural unit represented by Formula (1) is preferably represented by Formula (3); and the number-average molecular weight of the polyhydroxycarboxylic-acid-based resin (A) is preferably 5,000 or more, and 500,000 or less (claim 3)

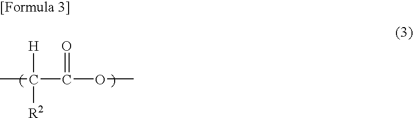

(where, R² in Formula (3) represents a hydrogen atom or an aliphatic hydrocarbon group having a carbon number ranging from 1 to 18).

Further, R² in Formula (3) is preferably a hydrogen atom or a methyl group (claim 4).

Still further, a ratio of (B) to the sum of (A) and (B) is preferably 1 wt % or more, and 70 wt % or less (claim 5).

Still further, the zero shear viscosity of the resin composition at a temperature higher by 30° C. than the melting point (° C.) of the resin composition is preferably 500 Pa·s or more (claim 6).

Another aspect of the present invention relates to a mold obtained by molding the resin composition of the present invention (claim 7).

Still another aspect of the present invention relates to a method for producing a resin composition, comprising mixing a polyhydroxycarboxylic-acid-based resin (A) comprising a structural unit represented by Formula (1) as a main structural unit and a polyoxytrimethyleneglycol-based resin (B) comprising a structural unit represented by Formula (2) as a main structural unit, both in the melting states (claim 8).

In this aspect, the number-average molecular weight of the polyoxytrimethyleneglycol-based resin (B) is preferably 400 or more, and 500,000 or less (claim 9).

In addition, the structural unit represented by Formula (1) is preferably represented by Formula (3); and the number-average molecular weight of the polyhydroxycarboxylic-acid-based resin (A) is preferably 5,000 or more, and 500,000 or less (claim 10).

Still another aspect of the present invention relates to a method for producing a resin composition comprising reacting a polyoxytrimethyleneglycol-based resin (B) comprising a structural unit represented by Formula (2) as a main structural unit with a compound represented by Formula (4) and/or (5) in the melting state(claim 11).

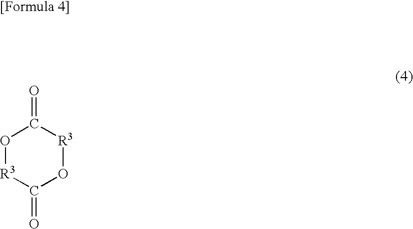

(where, R³s in Formula (4) represent divalent aliphatic hydrocarbon groups independent from each other)

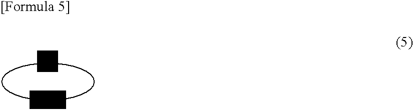

(where, R⁴ in Formula (5) represents a divalent aliphatic hydrocarbon group having a carbon number ranging from 1 to 10).

In this aspect, the compound represented by Formula (4) is preferably represented by Formula (6) (claim 12)

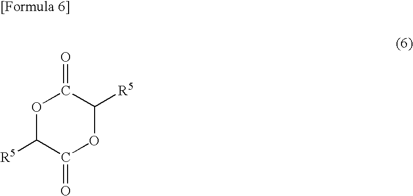

(where, R⁵s in Formula (6) represent hydrogen atoms or aliphatic hydrocarbon groups with a carbon number ranging from 1 to 18 independent from each other).

In addition, the number-average molecular weight of the polyoxytrimethyleneglycol-based resin (B) is preferably 400 or more, and 500,000 or less (claim 13).

Still another aspect of the present invention relates to a method for producing a resin composition, said method comprising mixing a resin composition (C) obtained through the method mentioned above with a polyhydroxycarboxylic-acid-based resin (D) comprising a structural unit represented by Formula (1) as a main structural unit (claim 14).

In this aspect, the structural unit represented by Formula (1) is preferably represented by Formula (3); and the number-average molecular weight of the polyhydroxycarboxylic-acid-based resin (D) is preferably 5,000 or more, and 500,000 or less (claim 15).

Further, a ratio of (C) to the sum of (C) and (D) is preferably 1 wt % or more, and 70 wt % or less (claim 16).

Still another aspect of the present invention relates to a resin composition produced by a method mentioned above (claim 17).

Still another aspect of the present invention relates to a copolymer comprising: at least a polyhydroxycarboxylic-acid-based block (A′) comprising a structural unit represented by Formula (1) at 50 wt % or more; and a polyoxytrimethyleneglycol-based block (B′) comprising a structural unit represented by Formula (2) at 50 wt % or more (claim 18).

In this aspect, the structural unit represented by Formula (1) is preferably represented by Formula (3) (claim 19).

### Effects of Invention

Consequently, the present invention provides a resin composition which contains a polyhydroxycarboxylic-acid-based resin and which has well-balanced properties such as thermal resistance, moldability, flexibility and others and provide the production method thereof.

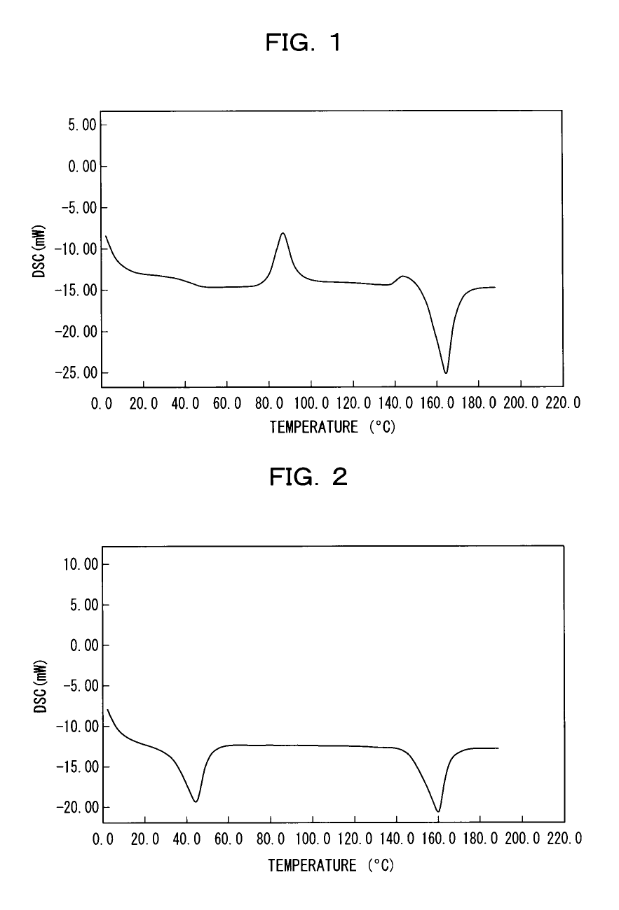

### BRIEF DESCRIPTION OF DRAWING

[FIG. 1] A spectrum obtained through Differential Scanning Calorimetry (DSC) performed on a resin composition of Example 7; and

[FIG. 2] A spectrum obtained through Differential Scanning Calorimetry (DSC) performed on a resin composition of Comparative Example 5.

### BEST MODE TO CARRY OUT INVENTION

Hereinafter, the present invention will now be detailed with reference to embodiments. However, the present invention is not limited to the description below and can be carried out with various changes and modifications without departing from the gist thereof.

Throughout the specification, the term “polymer” is used as the concept that collectively represents “homopolyer” having a single structural unit and “copolymer” having a number of structural units unless otherwise specified. In addition, the term “resin” used herein basically has the same meaning as the term “polymer”.

Throughout the specification, the structural unit of a polymer or a resin which structural unit is derived from a monomer is sometimes represented by the combination of the name of the monomer with the term “unit”. For example, the structural unit derived from oxytrimethyleneglycol is represented by the notation of an “oxytrimethylene-etherglycol[sic] unit”.

Further, throughout the specification, monomers that provide identical structural units are sometimes collectively called by substituting the term “unit” in the structural unit with the term “component”.

Throughout the specification, homopolymers and copolymers having a structural unit as the main structural unit are collectively represented in combination of the structural unit and the term “-based resin”. For example, a polyoxytrimethylene-etherglycol-based resin represents homopolymers and copolymers having the main structural unit formed of a polyoxytrimethylene etherglycol unit.

Throughout the specification, a main structural unit is a structural unit whose content in the structural units that form a polymer or a resin is usually 50 wt % or more, preferably 70 wt % or more, further preferably 80 wt % or more and is usually 100 wt % or less.

Throughout the specification, a block that forms a block copolymer which block is derived from a polymer or a resin is sometimes called through the use of the name of the polymer or the resin. In particular, a block derived from “XXX-based resin” is sometimes called “XXX-based block”, which also represents a block same in structure regardless of the actual derivation of the block. For example, a polyoxytrimethylene-etherglycol-based block represents a block derived from polyoxytrimethylene etherglycol and a block having the same structure.

Throughout the specification, the simple term “lactide” represents a generalized lactide, that is, a cyclic dimer of a hydroxyl acid unless otherwise specified. Further, attaching the name of a hydroxyl acid to a top of the term “lactide” sometimes represents the corresponding lactide. Specifically, “glycolic-acid lactide” represents a lactide of glycolic acid (so-called glycolide), and “lactic-acid lactide” represents a lactide of lactic acid (so-called a narrow lactide).

### [I. First Production Method]

A method for producing a resin composition of an aspect of the present invention (sometimes called “first production method of the present invention” or simply “first production method”) mixes a polyhydroxycarboxylic-acid-based resin (sometimes called the “resin (A)”) comprising a structural unit represented by Formula (1) as a main structural unit and a polyoxytrimethyleneglycol-based resin (sometimes called the “resin (B)”) comprising a structural unit represented by Formula (2) as a main structural unit, both in the melting states.

[Formula 7]

—R¹—COO— (1)

(where, R¹ in Formula (1) represents a divalent aliphatic hydrocarbon group).

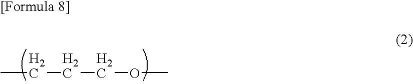

### [I-1.The Resin (A))

### <I-1-1. Overview>

The first production method of the present invention uses, as the resin (A), a resin containing the main structural unit of a structural unit (hereinafter called “structural unit (1)”) represented by Formula (1). The structural unit (1) is a unit derived from hydroxycarboxylic acid (that is, a hydroxycarboxylic-acid unit). Since the resin (A) contains the structural unit (1) as the main structural unit (that is, having the content in the entire structural units of 50 wt % or more), the resin (A) can be regarded as a“polyhydroxycarboxylic-acid-based resin” according to the above definition.

R¹ in Formula (1) represents a divalent aliphatic hydrocarbon group. The aliphatic hydrocarbon group may be of cyclic or of linear, which may be straight linear or branched. Linear is preferable, and straight linear is more preferable.

Above all, a preferable structural unit (1) is represented by Formula (3).

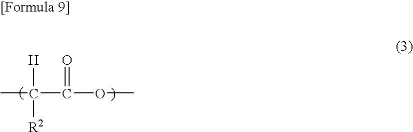

R² in Formula (3) represents a hydrogen atom or an aliphatic hydrocarbon group having a carbon number ranging from 1 to 18. The aliphatic hydrocarbon group may be of cyclic or of linear, which may be straight linear or branched. Linear is preferable, and straight linear is more preferable. The carbon number is not limited as long as ranges from 1 to 18, but preferably ranges from 1 to 10, more preferably ranges from 1 to 6.

Above all, R² is preferably a hydrogen atom or an aliphatic hydrocarbon group with the carbon number of 3 or less, more preferably a hydrogen atom, a methyl group, or an ethyl group, particularly preferably a hydrogen atom, or a methyl group. When R² is a hydrogen atom, the structural unit (1) has a unit derived from a glycolic acid (i.e., a glycolic-acid unit). When R² is a methyl group, the structural unit (1) has a unit derived from a lactic acid (i.e., a lactic-acid unit).

The ratio of structural unit (1) to the entire structural units of the resin (A) is usually 50 wt % or more as mentioned above, preferably 70 wt % or more, further preferably 80 wt % or more.

The structural unit (1) that forms the resin (A) may be a single kind (i.e., R¹ in Formula (1) is identical) or may be a combination of a number of kinds (i.e., R¹s in Formula (1) are different) at any ratio.

When the resin (A) contains a structural unit other than the structural unit (1), the kind of different structural unit is not limited and is therefore any kind. A structural unit other than the structural unit (1) may be a single kind or may be in combination with other one or more kinds at any ratio.

The number-average molecular weight (hereinafter sometimes represented by “Mn”) of the resin (A) can be any number unless significantly impairing the effects of the present invention, but is usually 5,000 or more, preferably 10,000 or more, and usually 500,000 or less, preferably 400,000 or less. An excessively low number-average molecular weight of the resin (A) may cause a resultant resin composition not to have a sufficient dynamic strength while an excessively high number-average molecular weight may result in difficulty in molding of the resultant resin composition and result in a low biodegradable rapidity. The number-average molecular weight of the resin (A) can be measured by means of Gel Permeation Chromatography (GPC) or the like.

The glass transition temperature (sometimes represented by “Tg”) of the resin (A) is usually 40° C. or higher, preferably 45° C. or higher, more preferably 50° C. or higher. An excessively low glass transition temperature Tg of the resin (A) may result in low dynamic strength at a normal temperature and in inclination to fusion. Conversely, the upper limit of the glass transition temperature Tg of the resin (A) is usually 65° C. or lower. The glass transition temperature Tg of the resin (A) can be measured by means of Differential Scanning Calorimetry (DSC) or the like.

Hereinafter, detailed description will now be made in relation to preferable examples of a resin of the component (A) being a polylactic-acid(sometimes called “PLA”)-based resin and a polyglycolic-acid(sometimes called “PGA”)-based resin. Using PLA and/or PGA as the resin of the component (A) can obtain a resin composition which is superior in thermal resistance and in appropriate flexibility to other polyoxycarboxylic-acid and which is superior in physical property balance.

### <I-1-2. Polylactic-Acid-Based Resin>

A polylactic-acid-based resin used as the resin (A) may be one on the market or may be one synthesized.

A derivation of the polylactic-acid-based resin is not also limited. However, considering the environmental aspect, it is preferable that the polylactic-acid-based resin derived from plants is used.

In addition, plural kinds of polylactic-acid-based resins having respective different derivations may used in combination at any ratio. Even in those cases, it is preferable that the content of polylactic-acid-based resins derived from plants in the entire polylactic-acid-based resin is usually 90 wt % or more, preferably 98 wt % or more, and further preferably 100 wt %.

A method for synthesizing the polylactic-acid-based resin is not limited, however is usually a lactide method in which lactic-acid lactide in the form of a cyclic dimer is synthesized from lactic acid or lactic-acid lactide is directly used as the material and then ring opening polymerization is carried out on lactic-acid lactide, or a direct polymerization method in which lactic acid serving as the material is directly subjected to dehydration condensation in a solvent. Among these methods, a direct polymerization method is preferable because no problem caused from remaining cyclic dimer arises.

Lactic acid and lactic-acid lactide serving as materials for a polylactic-acid-based resin may be L body, D body, a mixture of L body and D body (the mixing ratio of which is not particularly limited), or racemic body.

From the point of thermal resistance, L-body contained in the total lactic-acid units constitute of the polylactic-acid-based resin is usually 80 mol % or more, preferably 90 mol % or more.

The polylactic-acid-based resin may be copolymerized polylactic-acid in which other components with ester formability are copolymerized in addition to L-lactic acid and D-lactic acid.

Examples of a copolymerizable component are dicarboxylic acid components, diol components, hydroxycarboxylic acid components, and polyfunctional components each having three functions or more. These components may be used alone or in combination of two or more at any ratio.

An example of a dicarboxylic acid component is aliphatic dicarboxylic acid, such as succinic acid, adipic acid, suberic acid, sebacic acid, and decanedicarboxylic acid. Above all, succinic acid and adipic acid are preferable.

These components may be used alone or in combination of two or more at any ratio.

Examples of a diol component are ethylene glycol, propylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, and 1,4-cyclohexanediol.

These components may be used alone or in combination of two or more at any ratio.

Examples of a hydroxycarboxylic acid component are glycolic acid, 2-hydroxy-n-butyric acid, 2-hydroxycaproic acid, 2-hydroxy-3,3-dimethylbutyric acid, 2-hydroxy-3-methylbutyric acid, 2-hydroxyisocaproic acid, β-propiolactone, γ-butyrolactone, δ-valerolactone, ε-caprolactone, 4-metylcaprolactone, 3,5,5-trimetylcaprolacton, and 3,3,5-trimetylcaprolacton. These components may be used alone or in combination of two or more at any ratio.

Examples of a polyfunctional component having three functions or more are pentaerythritol, glycerin, trimethylolpropane, malic acid, citric acid, and tartaric acid.

These components may be used alone or in combination of two or more at any ratio.

When such a copolymerized component is used in synthesis of the polylactic-acid-based resin, the usage of the copolymerized component is usually less than 50 mol %, preferably 30 mol % or less, more preferably 20 mol % or less to the total polymerization components of the polylactic-acid-based resin assumed to be 100 mol %. The copolymerized component in excess of the above range may impair thermal resistance of the polylactic-acid-based resin.

The number-average molecular weight of the polylactic-acid-based resin is usually 5,000 or more, preferably 10,000 or more, and is usually 500,000 or less, preferably 400,000 or less. An excessively low number-average molecular weight of polylactic-acid may cause a resultant resin composition not to have sufficient dynamic strength, and an excessively high number-average molecular weight may result in difficulty in molding of the resultant resin composition and may result in low biodegradable rapidity. The number-average molecular weight of the polylactic-acid-based resin can be measured by means of Gel Permeation Chromatography (GPC) and other methods.

The glass transition temperature of the polylactic-acid-based resin is usually 40° C. or higher, preferably 45° C. or higher, more preferably 50° C. or higher. An excessively low glass transition temperature Tg of the polylactic-acid-based resin may result in low dynamic strength at a normal temperature and in inclination to fusion. Conversely, the upper limit of the glass transition temperature Tg of the polylactic-acid-based resin is usually 65° C. or lower. The glass transition temperature Tg of the polylactic-acid-based resin can be measured by means of DSC or the like.

<I-1-3. Polyglycolic-Acid-Based Resin>

When a polyglycolic-acid-based resin is used as the resin (A), the polyglycolic-acid-based resin to be used is usually one synthesized.

A derivation from the polyglycolic-acid-based resin is not limited. However, considering the environmental aspect, it is preferable that the polyglycolic-acid-based resin derived from plants is used.

In addition, plural kinds of polyglycolic-acid-based resins having respective different derivations may be used in combination at any ratio. Even in those cases, it is preferable that the content of polyglycolic-acid-based resins derived from plants in the entire polyglycolic-acid-based resin is usually 90 wt % or more, preferably 98 wt % or more, and further preferably 100 wt %.

A method for synthesizing the polyglycolic-acid-based resin is not limited, however is usually a glycolide method in which glycolide (glycolic-acid lactide) in the form of a cyclic dimer is synthesized from glycolic acid or glycolide is directly used as the material and then ring opening polymerization is carried out on glycolide, or a direct polymerization method in which glycolic acid serving as the material is directly subjected to dehydration condensation in a solvent. Among these methods, a direct polymerization method is preferable because no problem caused from remaining cyclic dimer arises.

The polyglycolic-acid-based resin may be copolymerized polyglycolic-acid in which another component with ester formability is copolymerized, in addition to glycolic acid.

Examples of a copolymerizable component are dicarboxylic acid components, diol components, hydroxycarboxylic acid components, and polyfunctional components each having three functions or more. These components may be used alone or in combination of two or more at any ratio.

An example of a dicarboxylic acid component is aliphatic dicarboxylic acid, such as succinic acid, adipic acid, suberic acid, sebacic acid, and decanedicarboxylic acid. Above all, succinic acid and adipic acid are preferable.

These components may be used alone or in combination of two or more at any ratio.

Examples of a diol component are ethylene glycol, propylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, and 1,4-cyclohexanediol.

These components may be used alone or in combination of two or more at any ratio.

Examples of a hydroxycarboxylic acid component are glycolic acid, 2-hydroxy-n-butyric acid, 2-hydroxycaproic acid, 2-hydroxy-3,3-dimethylbutyric acid, 2-hydroxy-3-methylbutyric acid, 2-hydroxyisocaproic acid, β-propiolactone, γ-butyrolactone, 5-valerolactone, ε-caprolactone, 4-metylcaprolactone, 3,5,5-trimetylcaprolacton, and 3,3,5-trimetylcaprolacton.

These components may be used alone or in combination of two or more at any ratio.

Examples of a polyfunctional component having three functions or more are pentaerythritol, glycerin, trimethylolpropane, malic acid, citric acid, tartaric acid.

These components may be used alone or in combination of two or more at any ratio.

When such a copolymerized component is used in synthesis of the polyglycolic-acid-based resin, the usage of the copolymerized component is usually less than 50 mol %, preferably 30 mol % or less, more preferably 20 mol % or less to the total polymerization components of the polyglycolic-acid-based resin assumed to be 100 mol %. A copolymerized component in excess of the above range may impair thermal resistance of the polyglycolic-acid-based resin.

The number-average molecular weight of the polyglycolic-acid-based resin is usually 5,000 or more, preferably 10,000 or more, and is usually 500,000 or less, preferably 400,000 or less. An excessively low number-average molecular weight of polyglycolic-acid [sic] may cause a resultant resin composition not to have sufficient dynamic strength, and an excessively high number-average molecular weight may result in difficulty in molding of the resultant resin composition and may result in low biodegradable rapidity. The number-average molecular weight of the polyglycolic-acid-based resin can be measured by means of Gel Permeation Chromatography (GPC) and other methods.

The glass transition temperature “Tg” of the polyglycolic-acid-based resin is usually 30° C. or higher, preferably 34° C. or higher, more preferably 40° C. or higher. An excessively low glass transition temperature Tg of the polyglycolic-acid-based resin may result in low dynamic strength at a normal temperature and in inclination to fusion. Conversely, the upper limit of the glass transition temperature Tg of the polyglycolic-acid-based resin is usually 65° C. or lower. The glass transition temperature Tg of the polyglycolic-acid-based resin can be measured by means of Differential Scanning Calorimetry (DSC) or the like.

### [I-2. Resin (B)]

The first production method of the present invention uses, as the resin (B), a resin including the main structural unit of a structural unit (hereinafter called “structural unit (2)”) represented by Formula (2). The structural unit (2) is a unit derived from trimethylene glycol (that is, an oxytrimethylene glycol unit). Since the resin (B) contains the structural unit (2) serving as the structural unit (that is, having the content in the entire main structural units of 50 wt % or more), the resin (B) can be regarded as a “polyoxytrimethylene-glycol-based resin” or a “PO3G-based resin” according to the above definition.

The ratio of structural unit (2) (PO3G units) to the entire structural units of the resin (B) is usually 50 wt % or more as mentioned above, preferably 70 wt % or more, further preferably 80 wt % or more.

When the resin (B) contains a structural unit other than the structural unit (2) (oxytrimethylene glycol unit), the kind of different structural unit is not limited and is therefore any kind.

An example of a structural unit other than the structural unit (2) is one derived from alkyleneglycol other than trimethylene glycol and is specifically a structural unit derived from ethylene glycol and a structural unit derived from tetramethylene glycol.

Another example of a structural unit other than structural unit (2) is a structural unit derived from a monomer except alkyleneglycol, and specifically is trimethylolethane, trimethylolpropane, pentaerythritol. It is preferable that, even if a repetitious unit derived from a monomer other than alkyleneglycol is contained, the content of the repetitious unit in the entire structural unit of the resin (B) is usually 10 wt % or less, preferably 5 wt % or less.

A structural unit other than the structural unit (2) may be a single kind or may be in combination of two or more kinds at any ratio.

The resin (B) can be obtained by polycondensation using a monomer in the form of linear monomer or cyclic monomer corresponding to the structural unit (2).

Specifically, the resin (B) may be a condensate of 1,3-propanediol or may be a condensate of oxetane. However, a condensate of 1,3-propanediol is preferable from a cost aspect.

When the resin (B) is a copolymer containing a structural unit other than the structural unit (2), it is sufficient that a monomer of the material of the structural unit other than the structural unit (2) is used jointly. For example, when the structural unit is polyoxytetramethylene glycol, it is sufficient that corresponding straight liner monomer 1,4-butanediol and/or corresponding cyclic monomer tetrahydrofuran (THF) is used jointly.

The PO3G -based resin of the resin (B) may be one synthesized. In synthesizing the PO3G-based resin, the method of synthesizing is not limited, but, for example, can be accomplished by dehydration polycondensation carried out on the above monomer units [sic] under the condition described in the publication of Japanese Patent Application Laid-Open (KOKAI) No. 2004-182974 or the like.

Alternatively, the PO3G-based resin can be synthesized in the method described in the specification of WO2004/101469 through the use of a material derived from plants. The combination of the resin (B) in the form of the PO3G-based resin obtained through this method and the resin (A) in the form of the polylactic-acid-based resin derived from plants makes it possible to produce a resin composition from material derived from plants.

The number-average molecular weight of the resin (B) can be any number unless significantly impairing the effects of the present invention, but is usually 400 or more, preferably 500 or more, and usually 500,000 or less, preferably 100,000 or less. An excessively low number-average molecular weight of the resin (B) may cause resultant resin composition to have a significantly low melting point and a significantly low glass transition temperature Tg while an excessively high number-average molecular weight of the resin (B) may make it difficult to synthesize the resin (B) and to handle the resin (B) due to an increased viscosity and may lower the reaction velocity.

The number-average molecular weight of the resin (B) can be measured by the method in which: hydroxyl groups at ends of the resin (B) that is the PO3G-based resin esterify with phthalic anhydride; the remaining phthalic anhydride is decomposed into phthalic acid; the hydroxyl group number is obtained by a back titration (a method of end-group titration) with alkali such as an sodium hydroxide solution; and the number-average molecular weight is calculated from the hydroxyl group number.

The glass transition temperature Tg of the resin (B) is usually −50° C. or higher, preferably −45° C. or higher, and is usually 0° C. or lower, preferably −20° C. or lower. An excessively low glass transition temperature Tg of the resin (B) may cause the resultant resin composition to have a significantly low glass transition temperature Tg. Conversely, an excessively high glass transition temperature Tg of the resin (B) may impair the flexibility and the impact resistance of the resultant resin composition. The glass transition temperature Tg of the resin (B) can be measured by means of Differential Scanning Calorimetry (DSC) or the like.

### [I-3. Production Conditions]

A first production method of the present invention is to mix the resin (A) and the resin (B) both in melting state under the conditions detailed below.

The amounts of the resin (A) and the resin (B) to be used are not limited. However, the amount of the resin (B) to be used to the sum of the resin (A) and the resin (B) is usually 1 wt % or more, preferably 5 wt % or more, further preferably 10 wt % or more, and usually 70 wt % or less, preferably 60 wt % or less, further preferably 50 wt % or less. An excessive low ratio of the resin (B) may lower the accelerating effect in cold crystallization and the softening effect of the resultant resin composition. An excessive large ratio may cause the resultant resin composition to have a low dynamic strength and an extremely low molecular weight.

Besides the resin (A) and the resin (B), another resin may be added which is exemplified by polyester, polyolefin, or polystyrene, and which may be produced from a material derived from biomass resource compounds. Examples of polyester are polyethylene terephthalate, polytrimethylene terephthalate, polybutylene terephthalate, and poly(ε-caprolactone). Examples of polyolefin are polypropylene, and polyethylene. These resins may be used alone or in combination of two or more at any ratio.

The timing at which another resin is added is not limited, and may be before the mixing, during the mixing, or after the mixing.

However, even if another resin is used, the amount of the resin to be used to the sum of the resin (A) and the resin (B) is usually 20 wt % or less, preferably 10 wt % or less, more preferably 5 wt % or less, further preferably 1 wt % or less.

In addition, another component may be added besides the resin (A), the resin (B) and another resin used as required. The component is a compound functioning as a catalyst, an antioxidant, a thermal stabilizer, a nucleator, a filler, a reinforcement agent, a flame retardant, an antistatic agent, a release agent, an ultraviolet absorber, a crosslinking agent, a viscosity adjusting agent, a slidability improving agent, a colorant, a conductive agent or the like.

These components may be used alone or in combination of two or more components at any ratio.

The timing at which another component is added is not also limited, and may be before the mixing, during the mixing, or after the mixing.

However, even if another component is used, the amount of the resin to be used to the sum of resin (A) and the resin (B) is usually 5 wt % or less, preferably 1 wt % or less.

Above all, a catalyst and/or an antioxidant are preferably used as the components.

The catalyst is preferably an ester interchanging catalyst in the estimation that mixing the resin (A) and the resin (B) makes an ester interchanging reaction. A preferable ester interchanging catalyst is tetra(n-butoxy) titanate.

The antioxidant is preferably a hindered phenol-based antioxidant and is specifically IRGANOX 1330 (produced by Ciba Specialty Chemicals).

The timing at which a catalyst and/or antioxidant is added is not limited, and may be before the mixing, during the mixing, or after the mixing, but is preferably before the mixing or during the mixing, particularly preferably before the mixing in the estimation that an ester interchanging reaction occurs during the mixing.

A mixing apparatus is not limited and is exemplified by a reaction container equipped with a stirrer or a twin-screw kneading extruder, between which the reaction container equipped with a stirrer is preferable.

The manner of mixing is not limited, and may be a batch process or a continuous process, between which batch process is preferable.

In the present invention, the resin (A) and the resin (B) are mixed, both in the melting states. In order to make the resins into a melting state, the temperature at which the mixing is carried out is usually set to be higher than the melting points of both the resin (A) and the resin (B).

The temperature at which the mixing is carried out is not limited as long as the temperature is higher than the melting points of both the resin (A) and the resin (B). For example, assuming that the resin (A) is a polylactic-acid-based resin, the temperature is usually 150° C. or higher, preferably 160° C. or higher, more preferably 170° C. or higher, and is usually 230° C. or lower, preferably 220° C. or lower, more preferably 210° C. or lower. Assuming that the resin (A) is a polyglycolic-acid-based resin, the temperature is usually 220° C. or higher, preferably 230° C. or higher, more preferably 240° C. or higher, and is usually 300° C. or lower, preferably 290° C. or lower, more preferably 280° C. or lower. When the temperature at the mixing is excessively low, the resin (A) serving as a material may not melt or an ester interchanging reaction may not occur. When the temperature is excessively high, the side reaction of the elimination of lactide (cyclic dimer of hydroxy acid) and others preferentially occurs.

The pressure at which the mixing is carried out is not limited, but is usually 1 Pa or higher, preferably 10 Pa or higher, and is usually 100 Pa or lower, preferably 30 Pa or lower. When the pressure at the mixing is excessively low, the reactant may insufficiently dry and the reaction velocity may be low. An excessively high pressure may promote sublimation of lactide (cyclic dimer of hydroxy acid) so that the drain tube may have a blockage.

The atmosphere in which the mixing is carried out is not limited, but is usually in a vacuum or in an inert gas atmosphere such as nitrogen gas, or argon gas.

The time period for which the mixing is carried out may vary with the conditions when the mixing, such as the temperature, the pressure, and the atmosphere and others, but it is usually 10 minutes or longer, preferably 30 minutes or longer, and usually 2 hours or shorter, preferably 1 hour or shorter. An excessively short mixing time period may not complete the ester interchanging reaction, while an excessively long time period may preferentially cause the side reaction of the elimination of lactide (cyclic dimer of hydroxy acid) and may cause deterioration or the like of the resin due to oxidizing reaction.

After the mixing, the obtained mixture without any processing may be used as the resin composition, or the obtained mixture after being subjected to subsequent processing can be used. An example of the subsequent processing is catalyst removal, catalyst deactivation, or solid phase polymerization.

### [I-4. First Resin Composition]

The resin composition (sometimes appropriately called the “first resin composition of the present invention” or simply the “first resin composition”) obtained trough the first production method detailed above usually contains the resin (A) and the resin (B) that are detailed above. The ratios of the resin (A) and the resin (B) are usually both within the ranges that are detailed in above [I-3 Production Conditions] and are approximately identical to the usage ratio described in the above [I-3 Production Conditions].

The first resin composition preferably contains a block copolymer (sometimes called the “copolymer of the present invention”) including a block derived from the resin (A) and a block derived from the resin (B).

The reason for generation of the copolymer of the present invention through the first production method has not been ascertained, but is estimated that mixing the resin (A) and the resin (B), both in the melting states causes an ester interchanging reaction between the resin (A) and the resin (B) to thereby generate the copolymer of the present invention.

The copolymer of the present invention is detailed in [V. Copolymer] below.

The first resin composition may contain another component, which is exemplified by those except the resin (A) and the resin (B) detailed in above [I-3. Production Conditions].

The number-average molecular weight of the first resin composition is not limited, but is usually 5,000 or more, preferably 10,000 or more, and is usually 500,000 or less, preferably 400,000 or less. An excessive low number-average molecular weight of the resin composition may result in low dynamic strength while an excessively high number-average molecular weight may make molding difficult and make the biodegradable rapidity low. However, some applications of the resin composition of the present invention allow the number-average molecular weight to increase by carrying out polymerization in the method detailed below.

The number-average molecular weight of the resin composition can be measured by means of GPC or others.

The other properties possessed by the first resin composition are identical to those possessed by resin compositions according to other aspects of the present invention and are therefore detailed in [III. Resin Composition] below.

### [II. Second Production Method]

A method for producing a resin composition according to another aspect of the present invention (hereinafter called the “second production method of the present invention” or simply the “second production method”) is to react the melting resin (B) described in the above first production method with compounds expressed by the Formula (4) and/or (5) below, being in the melting state.

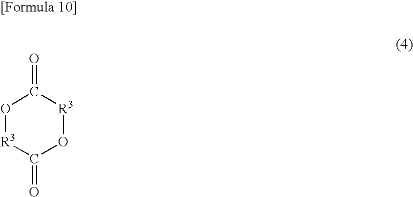

(where, R³s in Formula (4) represent divalent aliphatic hydrocarbon groups independent from each other)

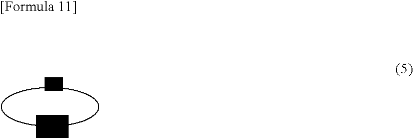

(where, R⁴ in Formula (5) represents a divalent aliphatic hydrocarbon group having a carbon number ranging from 1 to 10).

### [II-1. Compound (4)]

The second production method uses a compound (sometimes called “compound (4)”) expressed by above Formula (4). The compound (4) is a cyclic dimer of hydroxyl acid, i.e., lactide.

Similarly to R¹ in Formula (1), R³s in Formula (4) represent divalent aliphatic hydrocarbon groups independent from each other. The aliphatic hydrocarbon group may be of cyclic or of linear, which may be straight linear or branched. Linear is preferable, and straight linear is more preferable.

Above all, the compound (4) is preferably a compound expressed by Formula (6) (sometimes called “compound (6)”).

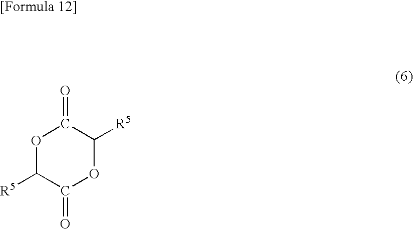

Similarly to R² in Formula (3), R⁵s in Formula (6) represent a hydrogen atom or aliphatic hydrocarbon groups with a carbon number ranging from 1 to 18. The aliphatic hydrocarbon group may be of cyclic or of linear, which may be straight linear or branched. Linear is preferable, and straight linear is more preferable. The carbon number is not limited as long as ranges from 1 to 18, but preferably ranges from 1 to 10, more preferably ranges from 1 to 6.

The two R⁵s in a single molecule of the compound (6) may be the same or may be different. However, considering the easiness of synthesis or obtaining, the R⁵s are preferably the same.

Above all, R⁵ is preferably a hydrogen atom or an aliphatic hydrocarbon group with the carbon number of 3 or less, more preferably a hydrogen atom, a methyl group, or an ethyl group, particularly preferably a hydrogen atom, or a methyl group. When R⁵ is a hydrogen atom, the compound (6) is glycolic-acid lactide (glycolide). When R⁵ is a methyl group, the compound (6) is lactic-acid lactide.

### [II-2. Compound (5)]

The second production method uses a compoundexpressed by Formula (5) (sometimes called “compound (5)”) as a substitution for the compound (4) or along with the compound (4).

R⁴ in Formula (5) represents a divalent aliphatic hydrocarbon group. The aliphatic hydrocarbon group may be of cyclic or of linear, which may be straight linear or branched. Linear is preferable, and straight linear is more preferable. The carbon number of the aliphatic hydrocarbon group is not limited as long as it is in the range of from 1 to 10, but is preferably in the range of from 1 to 6.

### [II-3. Production Conditions]

The second production method uses the above-described resin (B) and the compound(s) (4) and/or (5), and reacts the resin and the compound(s) by mixing the resin and the compound(s) being in the melting state.

Each of the resin (B), the compound (4), and the compound (5) may be a single kind or may be in combination of two or more kinds at any ratio.

The amounts of the resin (B), the compound (4), and the compound (5) to be used are not limited. The amount of the resin (B) to be used to the sum of the resin (B), the compound (4), and the compound (5) is usually 1 wt % or more, preferably 5 wt % or more, further preferably 10 wt % or more, and is usually 70 wt % or less, preferably 60 wt % or less, further preferably 50 wt % or less. An excessively small ratio of the resin (B) may lower the acceleating effect in cold crystallization and the softening effect of a resultant resin composition. An excessive large ratio may cause the resultant resin composition to have a low dynamic strength and an extremely low molecular weight.

Besides the resin (B), another resin may be added which is exemplified by polyester, polyolefin, or polystyrene, which may be produced from a material derived from biomass resource compounds. Examples of polyester are polyethylene terephthalate, polytrimethylene terephthalate, polybutylene terephthalate, and poly(ε-caprolactone). Examples of polyolefin are polypropylene, and polyethylene. These resins may be used alone or in combination of two or more at any ratio.

The timing at which another resin is added is not limited, and may be before the mixing, during the mixing, or after the mixing.

However, even if another resin is used, the amount of the resin to be used to the sum of the resin (B), the compound (4), and the compound (5) is usually 20 wt % or less, preferably 10 wt % or less, more preferably 5 wt % or less, further preferably 1 wt % or less.

Further, the resin (A) used in the first production method can be used jointly at any ratio in addition to the resin (B), the compound (4), and the compound (5).

Another component may be added besides the resin (B), the compound (4), the compound (5) and another resin used as required. The component is a compound functioning as a catalyst, an antioxidant, a thermal stabilizer, a nucleator, a filler, a reinforcement agent, a flame retardant, an antistatic agent, a release agent, an ultraviolet absorber, a crosslinking agent, a viscosity adjusting agent, a slidability improving agent, a colorant, a conductive agent or the like. The components may be used alone or in combination of two or more components at any ratio.

The timing at which another component is added is not also limited, and may be before the mixing, during the mixing, or after the mixing.

However, even if another component is used, the amount of the component to be used to the sum of resin (A) and the resin (B) is usually 5 wt % or less, preferably 1 wt % or less.

Above all, a catalyst and/or an antioxidant are preferably used as the components.

The catalyst is preferably a Lewis acid catalyst in the estimation that the mixing the resin (B), the compound (4), and the compound (5) prompts polymerization as detailed below. Examples of a Lewis acid catalyst is octane acid tin, n-tetrabutoxy titanate, tin chloride dihydrate, germanium oxide. However, octane acid tin and tin chloride dihydrate are preferable. The catalysts may be used alone or in combination of two or more at any ratio.

The antioxidant is preferably a hindered phenol-based antioxidant and specifically IRGANOX 1330 (produced by Ciba Specialty Chemicals). The antioxidant may be used alone or in combination with one or more at any ratio.

The timing at which a catalyst and/or antioxidant is added is not limited, and may be before the mixing, during the mixing, or after the mixing, but is preferably before the mixing or during the mixing, more preferably before the mixing in the estimation that ring-opening polymerization occurs during the mixing.

A mixing apparatus is not limited and is exemplified by a reaction container equipped with a stirrer or a twin-screw kneading extruder, between which the reaction container equipped with a stirrer is preferable.

The manner of mixing is not limited, and may be a batch process or a continuous process, between which batch process is preferable.

In the second embodiment, the resin (B), and the compound (4) and/or the compound (5) all being in the melting state are mixed to react with one another. In order to make the resin (B), the compound (4) and/or the compound (5) into the melting state, the temperature at which the mixing is carried out is usually set to be higher than the melting point of the resin (B).

The temperature at which the mixing is carried out is not limited as long as the temperature is higher than the melting point of the resin (B). For example, assuming that the resin (B) reacts with the compound (4) which is lactic-acid lactide, the temperature is usually 150° C. or higher, preferably 160° C. or higher, more preferably 170° C. or higher, and is usually 230° C. or lower, preferably 220° C. or lower, more preferably 210° C. or lower. Assuming that the resin (B) reacts with the compound (4) which is glycolic-acid lactide, the temperature is usually 220° C. or higher, preferably 230° C. or higher, more preferably 240° C. or higher, and is usually 300° C. or lower, preferably 290° C. or lower, more preferably 280° C. or lower. When the temperature at the mixing is excessively low, the resin (B) serving as a material may not melt or polymerization may not occur. When the temperature is excessively high, the side reaction of depolymerization and others preferentially occurs.

The pressure at which the mixing is carried out is not limited, but is usually 1 Pa or higher, preferably 10 Pa or higher, and is usually 100 Pa or lower, preferably 30 Pa or lower. When the pressure at the mixing is excessively low, the reactant may insufficiently dry and the reaction velocity may become low. An excessively high pressure may enhance sublimation of lactide (cyclic dimer of hydroxy acid) so that the drain tube may have a blockage.

The atmosphere in which the mixing is carried out is not limited, but is usually in a vacuum or in an inert gas atmosphere such as a nitrogen gas, or an argon gas.

The time period for which the mixing is carried out may vary with the conditions when the mixing, such as the temperature, the pressure, the atmosphere and others, but it is usually 10 minutes or longer, preferably 30 minutes or longer, and is usually 2 hours or shorter, preferably 1 hour or shorter. An excessively short mixing time period may not complete the polymerization, and an excessively long time period may preferentially cause the side reaction of depolymerization and may cause deterioration or the like of the resin due to oxidization.

Occurrence of the reaction between the resin (B) and the compound (4) and/or the compound (5) can be confirmed by means of GPC or others.

After the mixing, the obtained mixture without any processing may be used as the resin composition, or the obtained mixture after being subjected to subsequent processing can be used. An example of the subsequent processing is catalyst removal, catalyst deactivation, or solid phase polymerization.

### [II-4. Second Resin Composition]

The resin composition (sometimes appropriately called the “second resin composition of the present invention” or simply the “second resin composition”) obtained trough the second production method detailed above usually contains the resin (B) and the compound (4) and/or the compound (5) that are detailed above.

The second resin composition preferably contains a block copolymer (the copolymer of the present invention) containing blocks derived from the resin (A) and the resin(B) described in [I. First Production Method].

The reason for generation of the copolymer of the present invention through the second production method has not been ascertained, but is estimated that mixing the resin (B) and the compound (4), and/or the compound (5) all in the melting state to react with each other combines the compound (4) and/or the compound (5) to ends of the resin (B) and concurrently ring-opening polymerization occurs on the compound (4) and/or the compound (5) so that a block (a polyhydroxycarboxylic-acid-based block) having the same structure as the block derived from the resin (A) is formed.

The copolymer of the present invention is detailed in [V. Copolymer] below.

The second resin composition may contain another component, for example, except the resin (B), the compound (4), and the compound (5) detailed in above [II-3. Production Conditions].

The number-average molecular weight of the second resin composition is not limited, but is usually 5,000 or more, preferably 10,000 or more, and is usually 500,000 or less, preferably 400,000 or less. An excessive low number-average molecular weight of the resin composition may result in low dynamic strength while an excessively high number-average molecular weight may make molding difficult and make the biodegradable rapidity low. However, some applications of the resin composition of the present invention allow the number-average molecular weight to increase by carrying out polymerization in the method detailed below. The number-average molecular weight of the resin composition can be measured by means of GPC or others.

The other properties possessed by the second resin composition are identical to those possessed by the resin composition according to other aspects of the present invention and are therefore detailed in below [III. Resin Composition].

### [III. Resin Composition]

The resin composition of the present invention corresponds to one of (i) to (iii) below.

(i) the resin composition obtained through the first production method or the second production method (that is, the first resin composition or the second resin composition) or a resin composition obtained by adding another components to these resin composition (which is exemplified by a resin composition obtained through a third production method to be detailed below).

(ii) a resin composition containing at least the resin (A) and the resin (B)

(iii) a resin composition containing the copolymer of the present invention that is to be described below

It is sufficient that the resin composition of the present invention satisfies at least one of the above items (i) through (iii), preferably satisfies any two of the three items, and preferably satisfies all of the three items.

### [III-1. Properties of Resin Composition]

The resin composition of the present invention is superior in moldability.

Specifically, the resin composition of the present invention has a zero shear viscosity at the melting point (° C.)+30° C. of usually 500 Pa·s or higher, preferably 800 Pa·s or higher, more preferably 1,000 Pa·s or higher, and is usually 10,000 Pa·s or lower, preferably 5,000 Pa·s or lower, more preferably 2,000 Pa·s or lower. An excessively low and high zero shear viscosity may make molding difficult.

The melting point of the resin composition can be measured by means of DSC or the like, and the zero shear viscosity of the resin composition at the melting point (° C.) +30° C. can be measured with a stress-controlling rheometer or another device.

Further, the resin composition of the present invention is superior in thermal resistance.

Specifically, the glass transition temperature Tg of the resin composition of the present invention is usually 40° C. or higher, preferably 45° C. or higher, more preferably 50° C. or higher while the upper limit of the glass transition temperature Tg of the resin composition of the present invention is usually 65° C. or lower. An excessively low glass transition temperature Tg of the resin composition may result in low dynamic strength at normal temperature and result in inclination to fuse.

The glass transition temperature Tg of the resin composition of the present invention can be measured by means of DSC or the like.

Further, the resin composition of the present invention preferably has a moisture permeability being regurated. Specifically, the moisture permeability of the resin composition of the present invention is usually 200 or more, preferably 300 or more, and is usually 1,000 or less, preferably 800 or less.

The moisture permeability of the resin composition can be measured through, for example, the cup method in conformity with JIS Z 0208.

If being used in an application, such as a gas barrier film, requiring gas-barrier properties, the resin composition of the present invention is preferably superior in gas-barrier properties.

Specifically, the oxygen permeability coefficient of the resin composition of the present invention is usually 1×10⁻¹⁶ or less, preferably 3×10⁻¹⁷ or less. A resin composition with an excessively high oxygen permeability coefficient may not be used for an application as a gas-barrier film of the like.

The oxygen permeability coefficient of the resin composition can be measured with, for example, a gas permeability measuring device in conformity with JIS K 7126-2.

The resin composition of the present invention is preferably a cold-crystalline resin composition. The term of “cold-crystalline resin composition” in the present invention represents a resin composition with ability of cold crystallization.

In the present invention, the term that a resin composition is “cold-crystallized” means that the resin composition is crystallized at a temperature of the glass transition temperature or higher and also the melting point or lower during the temperature of the resin composition is rising. “Cold crystallization” is detailed in, for example, “SATURATED POLYESTER HANDBOOK” Nikkan Kogyo Shimbun Ltd., 1989, P 20 and P 230.

The ability of cold crystallization of a resin composition can be judged from whether or not Differential Scanning Calorimetry (DSC) performed under a temperature rising condition results in detection of an exothermic peak (hereinafter called “cold crystallization peak”) that indicates the crystallization of the resin composition at the temperature being the glass transition temperature or higher and being the melting point or lower.

Still further, the resin composition of the present invention is preferably superior in flexibility. Specifically, the storage elastic modulus (hereinafter sometimes represented by “E'”) of the resin composition of the present invention is, when the resin (A) is a polylactic-acid-based resin, for example, usually 4 GPa or lower, preferably 3.5 GPa or lower, preferably 3 GPa or lower. Assuming that the resin (A) is a polyglycolic-acid-based resin, the storage elastic modulus is usually 7 GPa or lower, preferably 6.5 GPa or lower, more preferably 6 GPa or lower. A resin composition with an excessively high storage elastic modulus E′ may have insufficient flexibility. The lower limit of the storage elastic modulus E′ is not particularly limited, but an excessively low storage elastic modulus E′ may make the resin composition to be used as a molding difficult. Therefore, the storage elastic modulus E′ is usually 0.1 GPa or higher, preferably 0.3 GPa or higher, more preferably 0.5 GPa or higher.

The storage elastic modulus E′ of a resin composition can be measured by means of a dynamic viscoelastic measurement or the like.

The reduced viscosity (hereinafter sometimes represented by “ηₛₚ/C”) of the resin composition of the present invention has an optimum range varying with contents of respective components and therefore cannot be generalized. However, the reduced viscosity of the resin composition is usually 0.3 or more, preferably 0.4 or more, and is usually 4 or less, preferably 3 or less. A resin composition with an excessively low reduced viscosity ηₛₚ/C may have a difficulty in melting molding and may impair physical properties, such as strength, extension, and elastic recovery, or may impair heat resistance. In the meanwhile, a resin composition with an excessively high reduced viscosity ηₛₚ/C may have a difficulty in melting and molding.

The reduced viscosity ηₛₚ/C of a resin composition can be measured with, an Ubbelohde solution viscometer or the like.

The resin composition of the present invention is preferably superior in transparence. The transparence of a resin composition can be measured through, for example, the measurement of a haze.

### [III-2. Chain Elongation Reaction/Solid Phase Polymerization]

The resin composition of the present invention can be applied to various usages as detailed blow. In the event of application, it is preferably to carry out chain elongation reaction or solid phase polymerization so that the molecular weight of the resin composition is increased to usually 50,000 or more, preferably 100,000 or more and therefore the moldability of the resin composition is improved.

A chain elongation reaction is usually carried out by adding a chain elongation agent to the resin composition of the present invention.

Examples of the chain elongation agent are polyvalence isocyanate, polyvalence carboxylic acid, polyvalence carboxylic anhydride, and polyvalence epoxy, among which diisocyanates and dicarboxylic anhydrides are preferable. These chain elongation agents may be used alone or in combination of two or more at any ratio.

The amount of the chain elongation agent to be used to the resin composition of the present invention to be assumed to be 100 wt % is usually 0.1 wt % or more, preferably 0.5 wt % or more, and is usually 5 wt % or less, preferably 3 wt % or less. The excessively low amount of the chain elongation agent may make it difficult to increase the molecular weight while the excessively high amount may gelate or solidificate the resin composition during the reaction.

The temperature at which the chain elongation reaction is carried out is not limited, but is usually 150° C. or higher, preferably 170° C. or higher, and is usually 300° C. or lower, preferably 280° C. or lower. An excessively low temperature at the chain elongation reaction may not melt the resin composition serving as a material while an excessively high temperature may preferentially cause the side reaction of the elimination of lactide (cyclic dimer of hydroxy acid).

The pressure at which the chain elongation reaction is carried out is not limited, but the preferable pressure is usually a normal pressure and therearound. The atmosphere in which the chain elongation reaction is carried out is not limited, but is usually in an inert gas atmosphere such as nitrogen gas, or argon gas. During the chain elongation reaction, the reactant may be appropriately stirred.

In the meanwhile, the solid phase polymerization is usually carried out while the resin composition of the present invention is stirred for the purpose of mixing.

The temperature at which the mixing is carried out is not limited. However, the temperature is usually 100° C. or higher, preferably 120° C. or higher, and is usually 250° C. or lower, preferably 220° C. or lower. An excessively high temperature may melt the resin composition while an excessively low temperature may make it difficult to proceed the solid phase polymerization.

The pressure at which the mixing is carried out is not limited, but the preferable pressure is usually a normal pressure.

The atmosphere in which the mixing is carried out is not limited, but is usually in an inert gas atmosphere such as nitrogen gas, or argon gas.

The time period for which the chain elongation reaction is carried out may vary with the conditions when the mixing, such as the temperature, the pressure, the atmosphere and others, but is usually 1 minute or longer, preferably 10 minutes or longer, and usually 1 hour or shorter, preferably 30 minutes or shorter. The excessively short chain elongation reaction time period may not complete the chain elongation reaction, and an excessively long time period may preferentially cause the side reaction of the elimination of lactide (cyclic dimer of hydroxy acid) and may cause deterioration, gelation, or the like of the resin due to oxidization.

### [III-3. Application of Resin Composition]

The resin composition of the present invention has a wide variety of applications, which are exemplified by fiber, film, sheet, tube, industrial parts, automobile parts, and electric/electronic parts. Specific examples of the applications are fibrous products such as clothing fiber and various filters; film products such as a biaxially-oriented film and a conductive film; hose such as hydraulic hose and pneumatic hose; automobile parts such as a constant velocity joint boot and a suspension boot; industrial parts such as various seals and packing, flexible coupling, a conveyer belt, a timing belt, and a compression spring; precision machinery parts such as a gear; electric/electronic parts such as a mobile telephone housing, a seismic control material, an antiseismic material, keyboard pads, conductive pads, OA rolls, telephone curl cords; and daily commodities such as a hair brush, a hot curler, ski boot sole, and a shoe inner sole.

### [IV. Third Production Method]

The resin compound (the first or second resin compound) obtained through the first or second production method can be used alone, but can be mixed with the above resin (A), i.e., the polyhydroxycarboxylic-acid-based resin, for use. Mixing the first or second resin composition with the polyhydroxycarboxylic-acid-based resin can obtain a resin composition which maintains the superior properties such as thermal resisitance of the polyhydroxycarboxylic-acid-based resin and which has sufficiently improved properties of moldability, flexibility and others.

Hereinafter, description will now be made in relation to a resin composition (sometimes called the “third resin composition of the present invention” or simply the “third resin composition”) obtained through a method (sometimes called the “third production method of the present invention” or simply the “third production method”) for mixing the first or second resin composition and the resin (A).

The third production method uses the first or second resin composition (sometimes called the “resin composition (C)”) and the resin (A) (sometimes called the “resin (D)”) that are to be mixed. The resin composition (C) has been detailed in the above [I-4.First resin composition] and [II-4. Second Resin Composition]. The resin (D) has been detailed in above [I-1. Resin (A)]. Each of the resin composition (C) and the resin (D) may be used alone or in combination of two or more kinds at any ratio.

The amount of each of the resin composition (C) and the resin (D) to be used is not limited, but the amount of the resin composition (C) to be used to the sum of the resin composition (C) and the resin (D) is usually 1 wt % or more, preferably 5 wt % or more, further preferably 10 wt % or more, and is usually 70 wt % or less, preferably 60 wt % or less, further preferably 50 wt % or less. An excessively low ratio of the resin composition (C) may make the resin (D) insufficiently flexible while an excessive high ratio may cause the resultant resin to have a low dynamic strength.

Besides the resin composition (C) and the resin (D), another component may be added, which is exemplified by an antioxidant, a thermal stabilizer, a nucleator, a flame retardant, an antistatic agent, a release agent, and an ultraviolet absorber. The components may be used alone or in combination of two or more at any ratio. The timing at which another component is added is not also limited, and may be before the mixing, during the mixing, or after the mixing. However, even if another component is used, the amount of the component to be used to the total of the resin composition (C) and the resin (D) is usually 5 wt % or less, preferably 1 wt % or less.

A mixing apparatus is not limited and is exemplified by a reaction container equipped with a stirrer or a twin-screw kneading extruder, between which the reaction container equipped with a stirrer is preferable.

The manner of mixing is not limited, and may be a batch process or a continuous process, between which batch process is preferable.

The temperature at which the mixing is carried out is not limited, but is usually 150° C. or higher, preferably 170° C. or higher, and is usually 300° C. or lower, preferably 280° C. or lower. An excessively low temperature at the mixing may not melt the resin composition (C) and the resin (D), serving as materials, while an excessively high temperature may preferentially cause the side reaction of the elimination of lactide (cyclic dimer of hydroxy acid) and others.

The pressure at the time of mixing is not limited but a preferable pressure is usually a normal pressure. The atmosphere in which the mixing is carried out is not limited, but is usually in an inert gas atmosphere such as nitrogen gas, or argon gas.

The time period for which the mixing is carried out may vary with the conditions when the mixing, such as the temperature, the pressure, the atmosphere and others, but is usually 1 minute or longer, preferably 5 minutes or longer, and is usually 30 minutes or shorter, preferably 15 minutes or shorter. An excessively short mixing time period may not complete the mixing and kneading, and an excessively long time period may preferentially cause the side reaction of the elimination of lactide (cyclic dimer of hydroxy acid) and may cause deterioration or the like of the resin due to oxidization.

After the mixing, the obtained third resin composition may be used without any processing, or may be used after being subjected to subsequent processing. An example of the subsequent processing is catalyst removal, catalyst deactivation, or solid phase polymerization.

The number-average molecular weight of the third resin composition is not limited, but is usually 5,000 or more, preferably 10,000 or more, and is usually 500,000 or less, preferably 400,000 or less. An excessively low number-average molecular weight of the resin composition may result in a low dynamic strength and an excessively high number-average molecular weight may make the molding difficult and may lower the biodegradable rapidity. However, some applications of the resin composition of the present invention allow the number-average molecular weight to increase by carrying out polymerization in the method detailed below. The number-average molecular weight of the resin composition can be measured by means of GPC or others.

The third resin composition corresponds to the resin composition of the present invention and therefore has the same properties described in the field of [III-1. Properties of Resin Composition] except of not being cold-crystalline resin composition.

### [V. Copolymer]

The resin composition (the first or second resin composition) obtained through the first or second production method preferably contains a block copolymer (hereinafter called the “copolymer of the present invention”) in which a block (hereinafter called the “polyhydroxycarboxylic-acid-based block” or simply the “block (A′)) derived from the resin (A), that is, the polyhydroxycarboxylic-acid-based resin, and a block (hereinafter called the “polyoxytrimethylene-glycol-based block” or simply the “block (B′)) derived from the resin (B), that is, a polyoxytrimethylene glycol-based resin are combined. Hereinafter, this copolymer of the present invention will now be detailed.

The block (A′) is derived from the resin (A) and contains the above structural unit (1) for the main structural unit, that is, at the content of 50 wt % or more. Beside the structural unit (1), the block (A′) may have one or more structural units which are not limited. It is exemplified by another structural unit other than the structural unit (1) in above [I-1. Resin (A)].

In the meanwhile, the block (B′) is derived from the resin (B) and contains the above structural unit (2) for the main structural unit, that is, at the content of 50 wt % or more.

Beside the structural unit (2), the block (B′) may have one or more structural units, which are not limited is exemplified by another structural unit other than the structural unit (2) in above [I-2. Resin (B)].

The number of blocks (A′) contained in the copolymer of the present invention may be one or may be two or more. If the copolymer of the present invention has two or more blocks (A′), the blocks (A′) may be the same or may be different.

Further, the number of blocks (B′) contained in the copolymer of the present invention may be one or may be two or more. If the copolymer of the present invention has two or more blocks (B′), the blocks (B′) may be the same or may be different. Besides the block (A′) and the block (B′), the copolymer of the present invention may have one or more other blocks.

The copolymer of the present invention can have any combining sequence of blocks.

The content of the copolymer of the present invention in the first or second resin composition is usually 90 wt % or more, preferably 95 wt % or more, further preferably 100 wt %. The presence and the content ratio of the copolymer of the present invention in the first or second resin composition can be confirmed by means of, for example, GPC or Nuclear Magnetic Resonance (NMR).

The physical properties (for example, the number-average molecular weight, and glass transition temperature Tg) and the properties (for example, flexibility, and transparency) of the resin composition of the present invention are assumed to be basically inheritances from the copolymer of the present invention.

### [VI. Molding]

As described above, the resin composition of the present invention can be used in various applications. In application, the resin composition is preferably molded into a desired shape and used in a molded form as a formation. The resin composition of the present invention is superior in formability and therefore can be finely molded with ease. The method for molding the resin composition of the present invention is not particularly limited and can be any molding method known to the public. Examples of the method are injection molding, extrusion molding, and blow molding. The shape of the molding is not limited and may be appropriately selected according to the application.

### Examples

Hereinafter, the present invention will now be further detailed with reference to Examples. However, the present invention should by no means be limited to the examples below. In the below description, the term “part(s)” represents a “weight part(s)” unless otherwise mentioned.

### [Measurement of Physical Properties]

The physical properties of resin compositions and resins of below Examples and Comparative Examples are measured by the following means. Hereinafter, the resin compositions and resins of below Examples and Comparative Examples are sometimes simply called “resin samples”.

Measurement of Reduced Viscosity ηₛₚ/C:

0.2 g of a resin sample was dissolved in 40 mL of a solvent in which phenol and 1,1,2,2-tetrachloroethane are mixed at a ratio of 1:1, by stirring the solvent at 150° C. for 15 minutes. The reduced viscosity ηₛₚ/C of the solution at 30° C. was measured with an Ubbelohde type viscometer (automated viscometer DT610 produced by Sentec Corp.). The symbol C here represents the solution concentration (g/dL).

Differential Scanning Calorimetry (DSC):

In conformity to JIS K 7121, a Differential Scanning Calorimetry (DSC) spectrum was measured with a Differential Scanning Calorimetry measurement apparatus (DSC220 produced by Seiko Instruments & Electronics Ltd.) while a resin sample was first heated from 25° C. to 260° C. at the temperature rising rate 20° C./min, then cooled to 0° C. at the temperature declining rate 10° C./min and further heated to 260° C. at the temperature rising rate 20° C./min. On the basis of the obtained DSC spectrum, the glass transition temperature Tg and the melting point of the resin sample were measured, and the cold-crystalline peak of the resin were detected.

Measurement of Storage Elastic Modulus E′:

The storage elastic modulus E′ of a resin sample was measured with an elastic spectrometer (DMS200 produced by Seiko Instruments & Electronics Ltd.) at the temperature rising rate 2° C./min and the frequency 1 Hz.

The resin sample subjected to the measurement was molded into a heat-pressed sheet having a thickness of 0.5 mm through heat pressing and cooling. The conditions of the heat pressing were that: a heat-pressing molder was used; the set temperatures of the heat pressing molder were 190° C. (for Examples 1-3 and Comparative Examples 1-3) and 250° C. (for Examples 4-6, and Comparative Example 4); the preheating time period was for 7 minutes; the heat-pressing pressure was 14.4 MPa; and the heat-pressing time period is for 2 minutes. The cooling conditions were that: a cooling-water-circulation cooling unit was used; the cooling pressure was 14.7 MPa; and the cooling time period is for 3 minutes. The obtained heat-pressed sheet was used for the measurement after having been rested under the conditions of the temperature of 25° C. and the humidity of 50% for two days.

Measurement of Zero Shear Viscosity:

The zero shear viscosity of a resin sample on a geometry of a parallel plate having a diameter of 20 mm was measured at the temperature of the melting point of the resin sample plus 30° C. with a stress-controlling rheometer (Visco Analyzer produced by Reologica). As the melting point of the resin sample, the temperature at the top of the melting point peak on the above DSC spectrum was used. In the measurement, the gap was lam, and the shear velocity was in the range of from 0.01 sec⁻¹ to 100 sec⁻¹. The viscosity at the flat potion of an apparent viscosity caused from Newtonian flow was regarded as the zero shear viscosity.

Measurement of Moisture Permeability:

The moisture permeability of a resin sample was measured under the atmosphere of the temperature of 40° C. and the humidity of 90% in a cup method in conformity with JIS Z 0208.

The resin sample subjected to the measurement was molded into a heat-pressed sheet having a thickness of about 50±10 μm through heat pressing and cooling. The conditions of the heat pressing were that: a heat-pressing molder was used; the set temperature of the heat pressing molder was 190° C.; the preheating time period was for 7 minutes; the heat-pressing pressure was 14.4 MPa; and the heat-pressing time period is for 2 minutes. The cooling conditions were that: a cooling-water-circulation cooling unit was used; the cooling pressure was 14.7 MPa; and the cooling time period is for 3 minutes. The obtained heat-pressed sheet was used for the measurement after having been rested under the conditions of the temperature of 23° C. and the humidity of 50% for 2 days.

Measurement of an Oxygen Permeability Coefficient:

The oxygen permeability coefficient of a resin sample was measured under the conditions of the temperature of 23° C., the humidity of 80%, and the permeating area of 50 cm² with a measurement unit of OX-TRAN 2/21 (produced by MOCON, Inc.) in conformity with JIS K 7126-2. The procedure of the measurement was: placing the resin sample in the measurement unit; starting the measurement upon confirmation that the temperature and the humidity were stable at the predetermined conditions; terminating the measurement at the time the measured value of the oxygen permeability coefficient came to be stable; and regarding the measured value at the stable state as the oxygen permeability coefficient.

The resin sample subjected to the measurement was molded into a heat-pressed sheet having a thickness of 0.5 mm through heat pressing and cooling. The conditions of the heat pressing were that: a heat-pressing molder was used; the set temperature of the heat pressing molder is 250° C.; the preheating time period was for 7 minutes; the heat-pressing pressure was 14.4 MPa; and the heat-pressing time period is for 2 minutes. The cooling conditions were that: a cooling-water-circulation cooling unit was used; the cooling pressure was 14.7 MPa; and the cooling time period is for 3 minutes. The obtained heat-pressed sheet was used for the measurement after having been rested under the conditions of the temperature of 23° C. and the humidity of 50% for 2 days.

Measurement of a Number-Average Molecular Weight:

The number-average molecular weight was measured by means of the Gel Permeation Chromatography (GPC) under the following conditions.

All resin samples were subjected to the measurement after being dissolved in a moving phase to be described below and then filtered through a PTFE (polytetrafluoroethylene: Teflon (Registered Trademark)) filter with meshes of 0.45 μm.

### Measurement Conditions for Examples 1-3 and Comparative Examples 1-3

Device: Tosoh HLC-8220GPC

Detector: RI (incorporated in the device)

Moving phase: CHCl₃ (Special Grade, produced by Wako Pure Chemical Industries, Ltd.)

Flow rate: 1.0 mL/min

Injection: 0.1 wt %×100 μL

Column: PL 10μ Mixed B (30 cm×2)

Column Temperature: 40° C.

Calibration Sample: monodisperse polystyrene

Calibration method: polystyrene conversion

Calibration curve approximation expression: cubic expression

### Measurement Condition for Examples 4-6 and Comparative Example 4

Device: Tosoh HLC-8220GPC

Detector: RI (incorporated in the device)

Moving phase: solution in which sodium trifluoroacetate (produced by KANTO CHEMICAL CO.,INC.) is dissolved in the concentration of 5 mM in HFIP (hexafluoroisopropanol, produced by Central Glass Co., Ltd.)

Flow rate: 0.2 mL/min

Injection: 0.1 wt %×10 μL

Column: Tosoh TSKgel (15 cm×2)

Column Temperature: 40° C.

Calibration Sample: monodisperse PMMA (polymethyl methacrylate)

Calibration method: PMMA conversion

Calibration curve approximation expression: cubic expression

Judgment of Transparency:

Through the use of pellets of a resin sample, heat pressing and cooling were carried out so that a heat-pressed sheet having a thickness of 2 mm is fabricated. The conditions of the heat pressing were that: a heat-pressing molder was used; the set temperature of the heat pressing molder was 190° C.; the preheating time period was for 7 minutes; the heat-pressing pressure was 4.4 MPa; and the heat-pressing time period is for 2 minutes. The cooling conditions were that: a cooling-water-circulation cooling unit was used; the cooling pressure was 14.7 MPa; and the cooling time period is for 3 minutes. The obtained heat-pressed sheet was used for the measurement after having been rested under the conditions of the humidity of 50% and the temperature of 23° C. for 2 days. The heat-pressed sheet was positioned on a printed matter which bore sentences having a font size of 11 points and was irradiated with 40 W fluorescent light from the height of 30 cm. If the sentences could be completely read by eye from the distance of 30 cm same in height with the fluorescent light, the resin sample was judged to “possess transparency”. If a part or the entire part of the sentences beneath the pressed sample tip could not be read, the resin sample was judged to “not possess transparency”.

### Synthesis Example 1

Polyoxytrimethylene glycol (PO3G) was synthesized in the following procedure to serve as a component of the resin composition of each Example.

A 400-ml separable flask equipped with a distiller tube, a nitrogen introducing tube, a thermometer, and a stirrer was charged with 300 g (3.94 mol) of 1,3-propanediol produced by Shell Ltd., while nitrogen is provided at the rate of 150 Nml/min. After charging 0.146 g (1.38 mmol) of sodium carbonate, 2.84 g (0.0275 mol) of concentrated sulfuric acid (95%) was deliberately added while the content was being stirred. The flask was soaked in an oil bath, which was then heated to 162° C. After the reaction has continued for 46 hours under the liquid temperature adjusted to be 162° C.±1° C., the flask was taken out of the oil bath and was left until being cooled to room temperature. Water generated during the reaction was removed by accompanying nitrogen. 50 g of the reactant liquid cooled to room temperature was moved to a 300 ml recovery flask, which was then charged with 50 g of desalted water and 50 g of tetrahydrofuran and was gently refluxed for 1 hour so that sulfuric ester was hydrolysized. After leaving the reactant until cooled to room temperature, the lower layer (aqueous phase) of the two separated layers was removed. 1.0 g of calcium hydroxide was added to the upper layer (oil phase) and after stirring at room temperature for 1 hour, 50 g of toluene was added. The reactant was heated to 60° C. and tetrahydrofuran, water and toluene were removed under reduced pressure. The obtained oil phase was dissolved in 100 g of toluene and then insoluble matter was removed by filtration through a 0.45 μm filter. The reactant was heated to 60° C. to remove toluene under reduced pressure and vacuum dried at 60° C. for 4 hours. Consequently, the product PO3G was obtained.

The hydroxyl value of the obtained PO3G is obtained through the above mentioned end-group titration, from which the number-average molecular weight is calculated to be 3,320.

### Example 1

A container equipped with a nitrogen introducing opening and pressure reducing opening was charged with 65 parts of polylactic-acid (LACEA H-100 produced by Mitsui Chemicals, Inc., number-average molecular weight 86,000), 35 parts of PO3G (number-average molecular weight 3,320) obtained in Synthesis Example 1, and further with 0.03 parts of tetra-n-butyltitanate (produced by KISHIDA CHEMICAL Co., Ltd.) and 0.27 parts of IRGANOX 1330 (antioxidant, produced by Ciba Specialty Chemicals). The content was vacuum dried under a reduced pressure by 20 Pa at 80° C. for 3 hours. After that, the content was heated from 80° C. to 190° C. taking 30 minutes under a reduced pressure by 20 Pa and polylactic-acid was thereby melted. Then, stirring was started and the content was mixed at 190° C. for 1 hour. At the time when sublimation of lactic-acid lactide is confirmed, mixing was stopped and the content (the resin composition) was taken out. The obtained resin composition did not exhibit the separation of materials that are polylactic-acid and PO3G.

In succession, 30 parts of the obtained resin composition and 70 parts of polylactic-acid were charged into a reaction container equipped with a nitrogen introducing opening and pressure reducing opening. The content was vacuum dried under a reduced pressure by 20 Pa at 80° C. for 3 hours. Then the pressure was regained with dry nitrogen and the content was heated from 80° C. to 190° C. taking 30 minutes under the flow of nitrogen to melt the content. After that, stirring is started and the content was kneaded at 190° C. for 10 minutes. The content which was sufficiently kneaded was taken out and was regarded as the resin composition of Example 1.

The moisture permeability, the zero shear viscosity, the storage elastic modulus E′, the reduced viscosity ηₛₚ/C, and the glass transition temperature Tg of the resin composition of Example 1 were measured. The result of the measurements is shown in Table 1 below.

### Example 2

A container equipped with a nitrogen introducing opening and pressure reducing opening was charged with 65 parts of polylactic-acid (LACEA H-100 produced by Mitsui Chemicals, Inc.), 35 parts of PO3G (number-average molecular weight 3,320) obtained in Synthesis Example 1, and further with 0.03 parts of tetra-n-butyltitanate (produced by KISHIDA CHEMICAL Co., Ltd.) and 0.27 parts of IRGANOX 1330 (antioxidant, produced by Ciba Specialty Chemicals). The content was vacuum dried under a reduced pressure by 20 Pa at 80° C. for 3 hours. After that, the content was heated from 80° C. to 190° C. taking 30 minutes under a reduced pressure by 20 Pa and polylactic-acid was thereby melted. Then, stirring was started and the content was mixed at 190° C. for 1 hour. At the time when sublimation of lactic-acid lactide is confirmed, mixing was stopped and the content (the resin composition) was taken out. The obtained resin composition did not exhibit the separation of materials that are polylactic-acid and PO3G.

In succession, 99 parts of the obtained resin composition and 1 part of hexamethylenediisocianate (produced by Tokyo Chemical Industry Co., Ltd.) were charged into a reaction container equipped with a nitrogen introducing opening and pressure reducing opening. The content was heated from 80° C. to 190° C. taking 30 minutes under the flow of nitrogen and was thereby melted. After that, stirring is started and the content was kneaded at 190° C. for 10 minutes. The content which was sufficiently kneaded was taken out and was regarded as the resin composition of Example 2.

The moisture permeability, the zero shear viscosity, the storage elastic modulus E′, the reduced viscosity ηₛₚ/C, and the glass transition temperature Tg of the resin composition of Example 2 were measured. The result of the measurements is shown in Table 1 below.

### Example 3

A container equipped with a nitrogen introducing opening and pressure reducing opening was charged with 89 parts of L-lactic-acid lactide (produced by Tokyo Chemical Industry Co., Ltd.), 11 parts of PO3G (number-average molecular weight 3,320) obtained in Synthesis Example 1, and further with 0.03 parts of tin octanate (Tokyo Chemical Industry Co., Ltd.) and 0.27 parts of IRGANOX 1330 (antioxidant, produced by Ciba Specialty Chemicals). The content was vacuum dried under a reduced pressure by 20 Pa at 80° C. for 3 hours. After that, the content was heated from 80° C. to 190° C. under a reduced pressure by 20 Pa taking 30 minutes and L-lactic-acid lactide was thereby melted. Then, stirring was started and the content was mixed at 190° C. for 3 hours. Then the content was taken out and was regarded as the resin composition of Example 3.

The moisture permeability, the zero shear viscosity, the storage elastic modulus E′, the reduced viscosity ηₛₚ/C, and the glass transition temperature Tg of the resin composition of Example 3 were measured. The result of the measurements is shown in Table 1 below.

### Comparative Example 1

A resin composition was synthesized in the same manner as Example 1 except for PEG (polyethylene glycol)(Wako Pure Chemical Industries, Ltd., number-average molecular weight 3,000) as substitute for PO3G. The obtained resin composition is regarded as the resin composition of Comparative Example 1.

The moisture permeability, the zero shear viscosity, the storage elastic modulus E′, the reduced viscosity ηₛₚ/C, and the glass transition temperature Tg of the resin composition of Comparative Example 1 were measured. The result of the measurements is shown in Table 1 below.

### Comparative Example 2

A resin composition was synthesized in the same manner as Example 2 except for PEG (polyethylene glycol)(Wako Pure Chemical Industries, Ltd., number-average molecular weight 3,000) as substitute for PO3G. The obtained resin composition is regarded as the resin composition of Comparative Example 2.

The moisture permeability, the zero shear viscosity, the storage elastic modulus E′, the reduced viscosity ηₛₚ/C, and the glass transition temperature Tg of the resin composition of Comparative Example 2 were measured. The result of the measurements is shown in Table 1 below.

### Comparative Example 3

Polylactic acid (LACEA H-100, Mitsui Chemicals, Inc.) was used as the resin of Comparative Example 3. The moisture permeability, the zero shear viscosity, the storage elastic modulus E′, the reduced viscosity ηₛₚ/C, and the glass transition temperature Tg of the resin composition of Comparative Example 3 were measured. The result of the measurements is shown in Table 1 below.

### [Result]

TABLE 1

| | | | | | storage | | glass |
|---|---|---|---|---|---|---|---|
| | | PAG | moisture | zero shear | elastic | reduced | transition |
| | Material | content *2 | permeability *3 | viscosity | modulus E′ | viscosity | temperature Tg |
| | Components *1 | (wt %) | (g/m² · 24 h) | (Pa · s) | (GPa) | ηₛₚ/C (dL/g) | (° C.) |
| Example 1 | PLA, | 11 | 308 | 2200 | 2.9 | 1.2 | 55 |
| | PO3G | | (55 μm) | | | | |
| Example 2 | PLA, | 35 | 707 | 7700 | 1.6 | 1.4 | 49 |
| | PO3G, | | (59 μm) | | | | |
| | HDI | | | | | | |
| Example 3 | lactic-acid lactide, | 11 | 327 | 1900 | 2.6 | 0.9 | 53 |
| | PO3G | | (52 μm) | | | | |
| Comparative | PLA, | 11 | 633 | 300 | 3.4 | 1.1 | 38 |
| Example 1 | PEG | | (45 μm) | | | | |
| Comparative | PLA, | 35 | 3000 | 420 | 0.17 | 0.9 | immesurable |
| Example 2 | PEG, | | (66 μm) | | | | |
| | HDI | | | | | | |
| Comparative | PLA | 0 | 191 | 1500 | 4.5 | 1.9 | 64 |
| Example 3 | (Mn = 86000) | | (61 μm) | | | | |

*1 PLA represents polylactic-acid; PO3G represents polyoxytrimethylene glycol; PEG represents polyethylene glycol; and HDI represents hexamethylenediisocianate.
*2 representing contents of polyalkylene glycol (polyoxytrimethylene glycol or polyethylene glycol) to the resin compositions or the resins of Examples or Comparative Examples
*3 accompanying the thickness of the heat-press sheet used for the measurement in brackets

Table 1 indicates the following results. That is, the resin compositions of Examples 1-3 have appropriate moisture permeability, low storage elastic modulus E′ which means flexible, and high glass transition temperature Tg, which means superior in thermal resistance. In addition, the resin compositions are high in zero shear viscosity and are therefore easily molded.

On the other hand, the resin composition of Comparative Example 1 has a fine moisture permeability while it has a high storage elastic modulus E′, which means inferior in flexibility.

The resin composition of Comparative Example 2 has an extremely poor moisture permeability.

The resin composition of Comparative Example 3 is superior in moisture permeability while it has a high storage elastic modulus E′, which means inferior in flexibility.

### Synthesis Example 2

A reaction container equipped with a nitrogen introducing opening and a pressure reducing opening was charged with 10 g of glycolide (produced by Wako Pure Chemical Industries, Ltd.) and 0.01 g of tin chloride dihydrate (produced by Wako Pure Chemical Industries, Ltd.) and the content was vacuum dried under a reduced pressure by 20 Pa at 80° C. for 3 hours. Then the content was heated from 80° C. to 172° C. under a reduced pressure by 20 Pa taking 30 minutes in order to melt glycolide. Then the reaction was continued at 172° C. for 7 hours and polyglycolic-acid (PGA) was thereby obtained.

The obtained PGA was measured by means of GPC, which obtained the number-average molecular weight of 63,000.

### Example 4

A container equipped with a nitrogen introducing opening and pressure reducing opening was charged with 65 parts of PGA (number-average molecular weight 63,000) obtained through Synthesis Example 2, 35 parts of polyoxytrimethylene glycol (number-average molecular weight 3,320) obtained in Synthesis Example 1, and further with 0.03 parts of tetra-n-butyltitanate (produced by KISHIDA CHEMICAL Co., Ltd.) and 0.27 parts of IRGANOX 1330 (antioxidant, produced by Ciba Specialty Chemicals). The content was vacuum dried under a reduced pressure by 20 Pa at 80° C. for 3 hours. After that, the content was heated from 80° C. to 250° C. under a reduced pressure by 20 Pa taking 30 minutes to melt PGA. Then, stirring was started and the content was mixed at 250° C. for 1 hour.

In succession, 14 parts of the obtained resin composition and 86 parts of PGA obtained through Synthesis Example 2 were charged into a reaction container equipped with a nitrogen introducing opening and pressure reducing opening. The content was vacuum dried under a reduced pressure by 20 Pa at 80° C. for 3 hours. Then the pressure was regained with dry nitrogen and the content was heated from 80° C. to 250° C. under the flow of nitrogen taking 30 minutes and was thereby melted. After that, stirring is started and the content was kneaded at 250° C. for 10 minutes. The content which was sufficiently kneaded was taken out and is regarded as the resin composition of Example 4.

The reduced viscosity ηₛₚ/C, the zero shear viscosity, the storage elastic modulus E′, and the oxygen permeability coefficient of the resin composition of Example 4 were measured. The result of the measurements is shown in Table 2 below.

### Example 5

A container equipped with a nitrogen introducing opening and pressure reducing opening was charged with 65 parts of PGA (number-average molecular weight 63,000) obtained through Synthesis Example 2, 35 parts of PO3G (number-average molecular weight 3,320) obtained in Synthesis Example 1, and further with 0.03 parts of tetra-n-butyltitanate (produced by KISHIDA CHEMICAL Co., Ltd.) and 0.27 parts of IRGANOX 1330 (antioxidant, produced by Ciba Specialty Chemicals). The content was vacuum dried under a reduced pressure by 20 Pa at 80° C. for 3 hours. After that, the content was heated from 80° C. to 250° C. under a reduced pressure by 20 Pa taking 30 minutes and PGA was thereby melted. Then, stirring was started and the content was mixed at 250° C. for 1 hour.

In succession, 30 parts of the obtained resin composition and 70 parts of PGA obtained through Synthesis Example 2 were charged into a reaction container equipped with a nitrogen introducing opening and pressure reducing opening. The content was vacuum dried under a reduced pressure by 20 Pa at 80° C. for 3 hours. Then the pressure was regained with dry nitrogen, and the content was heated from 80° C. to 250° C. under the flow of nitrogen taking 30 minutes and was thereby melted. After that, stirring is started and the content was kneaded at 250° C. for 10 minutes. The content which was sufficiently kneaded was taken out and was regarded as the resin composition of Example 5.

The reduced viscosity ηₛₚ/C, the zero shear viscosity, the storage elastic modulus E′, and the oxygen permeability coefficient of the resin composition of Example 5 were measured. The result of the measurements is shown in Table 2 below.

### Example 6

A container equipped with a nitrogen introducing opening and pressure reducing opening was charged with 65 parts of PGA (number-average molecular weight 63,000) obtained through Synthesis Example 2, 35 parts of PO3G (number-average molecular weight 3,320) obtained through Synthesis Example 1, and further with 0.03 parts of tetra-n-butyltitanate (produced by KISHIDA CHEMICAL Co., Ltd.) and 0.27 parts of IRGANOX 1330 (antioxidant, produced by Ciba Specialty Chemicals). The content was vacuum dried under a reduced pressure by 20 Pa at 80° C. for 3 hours. After that, the content was heated from 80° C. to 250° C. under a reduced pressure by 20 Pa taking 30 minutes and PGA was thereby melted. Then, stirring was started and the content was mixed at 250° C. for 1 hour. At the time when sublimation of glycol-acid lactide is confirmed, mixing was stopped and the content (the resin composition) was taken out. The obtained resin composition did not exhibit the separation of materials that are PGA and PO3G.

In succession, 99 parts of the obtained resin composition and 1 part of hexamethylenediisocianate (Tokyo Chemical Industry Co., Ltd.) were charged into a reaction container equipped with a nitrogen introducing opening and pressure reducing opening. The content was heated from 80° C. to 250° C. under the flow of nitrogen taking 30 minutes and was thereby melted. After that, stirring is started and the content was kneaded at 250° C. for 10 minutes. The content which was sufficiently kneaded was taken out and was regarded as the resin composition of Example 6.

The reduced viscosity ηₛₚ/C, the zero shear viscosity, the storage elastic modulus E′, and the oxygen permeability coefficient of the resin composition of Example 6 were measured. The result of the measurements is shown in Table 2 below.

### Comparative Example 4

PGA obtained through Synthesis Example 2 was used as the resin of Comparative Example 4, whose reduced viscosity ηₛₚ/C, zero shear viscosity, storage elastic modulus E′ and oxygen permeability coefficient were measured. The result of the measurements is shown in Table 2 below. [Result]

TABLE 2

| | | | | | storage | oxygen | glass |
|---|---|---|---|---|---|---|---|
| | | | reduced | zero shear | elastic | permeability | transition |
| | Material | PAG content *5 | viscosity ηₛₚ/C | viscosity | modulus E′ | coefficient *6 | temperature |
| | Components *1 | (wt %) | (dL/g) | (Pa · s) | (GPa) | (mol · m/m² · s · Pa) | Tg (° C.) |
| Example 4 | PGA, | 4.9 | 1.4 | 1500 | 5.7 | <1.22 × 10⁻¹⁹ | immesurable |
| | PO3G | | | | | | |
| Example 5 | PGA, | 11 | 1.0 | 1000 | 4.1 | <1.22 × 10⁻¹⁹ | 43 |
| | PO3G | | | | | | |
| Example 6 | PGA, | 35 | 0.7 | 1000 | 0.2 | 2.73 × 10⁻¹⁷ | 34 |
| | PO3G, | | | | | | |
| | HDI | | | | | | |
| Comparative | PGA | 0.0 | 1.7 | 5500 | 7.2 | 1.24 × 10⁻¹⁹ | 46 |
| Example 4 | (Mn = 63000) | | | | | | |

*4 PGA represents polyglycolic-acid PO3G represents polyoxytrimethylene glycol; HDI represents hexamethylenediisocianate; and EVOH represents ethylene-vinyl alcohol copolymer.
*5 representing contents of polyalkylene glycol (polyoxytrimethylene glycol or polyethylene glycol) to the resin compositions or the resins of Examples or Comparative Examples
*6 oxygen permeability coefficients of Examples 4 and 5 are the measurable limit or less.

Table 2 indicates the following results.

That is, the resin compositions of Examples 4-6 have a low storage elastic modulus E′, which means flexible, and low oxygen permeability coefficient, which means superior in gas barrier property.

On the other hand, the resin composition of Comparative Example 4 has a high storage elastic modulus E′, which means inferior in flexibility.

### Example 7

A container equipped with a nitrogen introducing opening and pressure reducing opening was charged with 65 parts of polylactic-acid (LACEA H-100 produced by Mitsui Chemicals), 35 parts of polyoxytrimethylene glycol (number-average molecular weight 3,320), and further with 0.03 parts of tetra-n-butyltitanate (produced by KISHIDA CHEMICAL Co., Ltd.) and 0.27 parts of IRGANOX 1330 (antioxidant, produced by Ciba Specialty Chemicals). The content was vacuum dried under a reduced pressure by 20 Pa at 80° C. for 3 hours. After that, the content was heated from 80° C. to 190° C. under a reduced pressure by 20 Pa taking 30 minutes and polylactic-acid was thereby melted. Then, stirring was started and the content was mixed at 190° C. for 1 hour. At the time when sublimation of lactic-acid lactide is confirmed, mixing was stopped and the content was taken out and was regarded as the resin composition of Example 7. The obtained resin composition of Example 7 did not exhibit the separation of materials that are polylactic-acid and polyoxytrimethylene glycol.

For the resin composition of Example 7, measurement of the reduced viscosity ηₛₚ/C, Differential Scanning Calorimetry (DSC), judgment of transparency, measurements of zero shear viscosity and the glass transition temperature Tg were carried out. The result of measurements is shown in Table 3. In addition, the spectrum obtained through Differential Scanning Calorimetry (DSC) is shown in FIG. 1. While the temperature is rising, an exothermic peak (cold-crystalline peak) which indicates occurrence of crystallization was detected at the temperature of 87° C. which is the glass transition temperature (42.3° C.) of the resin composition or higher and which is the melting point (164.5° C.) or lower. The peak area of the cold-crystalline peak was 14.3 J/g.

### Comparative Example 5

A resin composition was produced under the same condition as Example 7 except for polyethylene glycol (Polyethylene Glycol 4,000 (number-average molecular weight 3,000), produced by Wako Pure Chemical Industries, Ltd.) as substitute for polyoxytrimethylene glycol. The obtained resin composition is regarded as the resin composition of Comparative Example 5. The resin composition of Comparative Example 5 did not exhibit separation of materials that are polylactic-acid and polyethylene glycol.

For the resin composition of Comparative Example 5, measurement of the reduced viscosity ηₛₚ/C, Differential Scanning Calorimetry (DSC), judgment of transparency, measurements of zero shear viscosity and the glass transition temperature Tg were carried out. The result of measurements is shown in Table 3. In addition, the spectrum obtained through Differential Scanning Calorimetry (DSC) is shown in FIG. 2. While the temperature is rising, no cold-crystalline peak defined as above was detected.

### [Result]

TABLE 3

| | | | reduced | | | glass |
|---|---|---|---|---|---|---|
| | | cold- | viscosity | | zero shear | transition |
| | material | crystalline | ηₛₚ/C | | viscosity | temperature |
| | components *7 | peak *8 | (dL/g) | Transparency *9 | (Pa · s) | Tg (° C.) |
| Example 7 | PLA, | 87° C., | 0.60 | ◯ | 1000 | 42.3 |
| | PO3G | 14.3 J/g | | | | |
| Comparative | PLA, | not detected | 0.47 | X | 250 | immeasurable |
| Example 5 | PEG | | | | | |

*7 PLA represents polylactic-acid; PO3G represents polyoxytrimethylene glycol; and PEG represents polyethylene glycol.
*8 Samples the cold-crystalline peaks of which were detected through Differential Scanning Calorimetry (DSC) were represented by the temperature and the peak area thereof are shown; and samples the cold-crystalline peaks of which were not detected were represented by “not detected”
*9 “◯” represents the judgment of possessing of transparency through the above procedure and “X” represents the judgment of not possessing of transparency.

The above result revealed the following.

That is, the resin composition of Example 7 formed of PLA and PO3G was cold-crystalized but the resin composition of Comparative Example 5 formed of PLA and PEG was not cold-crystalized. In addition, pure PLA (LACEA H-100, produced by Mitsui Chemicals, Inc.) used as one of the materials was not cold-crystalized.

From the above results, mixing PLA and PO3G can obtain a resin composition having cold-crystalline properties.

### INDUSTRIAL APPLICABILITY

The resin composition of the present invention has a wide variety of applications, which are exemplified by fiber, film, sheet, tube, industrial parts, automobile parts, and electric/electronic parts. Specific examples of the applications are fibrous products such as clothing fiber and various filters; film products such as a biaxially-oriented film and a conductive film; hose such as hydraulic hose and pneumatic hose; automobile parts such as a constant velocity joint boot and a suspension boot; industrial parts such as various seals and packing, flexible coupling, a conveyer belt, a timing belt, and a compression spring; precision machinery parts such as a gear; electric/electronic parts such as a mobile telephone housing, a seismic control material, an antiseismic material, keyboard pads, conductive pads, OA rolls, telephone curl cords; and daily commodities such as a hair brush, a hot curler, ski boot sole, and a shoe inner sole.

The present invention is detailed with reference to particular examples. However, it is obvious to those skilled in the art that various modification can be suggested without departing from the gist and scope of the present invention.

The present patent application is based on Japanese Patent application (Application No. 2007-8349) filed on Jan. 17, 2007 and on Japanese Patent Application (Application No. 2007-85801) filed on Mar. 28, 2007, the entire of which are incorporated in the present patent application by reference.

1.-19. (canceled)

20. A resin composition comprising
a polyhydroxycarboxylic-acid-based resin (A) having a structural unit represented by Formula (1) as a main structural unit; and
a polyoxytrimethyleneglycol-based resin (B) having a structural unit represented by Formula (2) as a main structural unit
—R¹—COO— (1)
wherein R¹ in Formula (1) represents a divalent aliphatic hydrocarbon group.

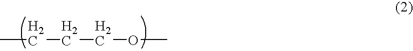

21. The resin composition according to claim 20, wherein the number-average molecular weight of the polyoxytrimethyleneglycol-based resin (B) is between 400 and 500,000.

22. The resin composition according to claim 20, wherein:
the structural unit of Formula (1) is represented by Formula (3); and
the number-average molecular weight of the polyhydroxycarboxylic-acid-based resin (A) is between 5,000 and 500,000. 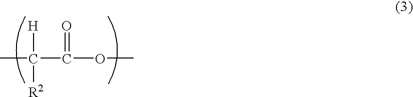
wherein R² in Formula (3) represents a hydrogen atom or an aliphatic hydrocarbon group having a carbon number ranging from 1 to 18.

23. The resin composition according to claim 22, wherein R² in Formula (3) is a hydrogen atom or a methyl group.

24. The resin composition according to claim 20, wherein a ratio of (B) to the sum of (A) and (B) is between 1 wt % and 70 wt %.

25. The resin composition according to claim 20, wherein the zero shear viscosity of the resin composition at a temperature higher by 30° C. than the melting point (° C.) of the resin composition is 500 Pa·s or more.

26. A mold obtained by molding a resin composition defined in claim 20.

27. A method for producing a resin composition, comprising mixing a melted polyhydroxycarboxylic-acid-based resin (A) having a structural unit represented by Formula (1) as a main structural unit and a melted polyoxytrimethyleneglycol-based resin (B) having a structural unit represented by Formula (2) as a main structural unit
—R¹—COO— (1)
wherein R¹ in Formula (1) represents a divalent aliphatic hydrocarbon group.

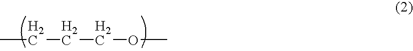

28. The method for producing a resin composition according to claim 27, wherein the number-average molecular weight of the polyoxytrimethyleneglycol-based resin (B) is between 400 and 500,000.

29. The method for producing a resin composition according to claim 27, wherein:
the structural unit of Formula (1) is represented by Formula (3); and
the number-average molecular weight of the polyhydroxycarboxylic-acid-based resin (A) is between 5,000 and 500,000. 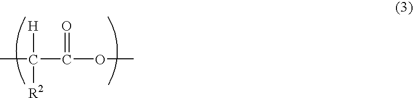
wherein R² in Formula (3) represents a hydrogen atom or an aliphatic hydrocarbon group having a carbon number ranging from 1 to 18.

30. A method for producing a resin composition, comprising reacting a melted polyoxytrimethyleneglycol-based resin (B) having a structural unit represented by Formula (2) as a main structural unit with a melted compound represented by Formula (4) and/or (5). 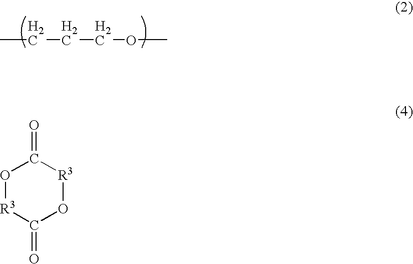
wherein the R³s in Formula (4) represent divalent aliphatic hydrocarbon groups independent from each other 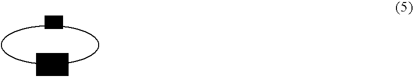
wherein R⁴ in Formula (5) represents a divalent aliphatic hydrocarbon group having a carbon number ranging from 1 to 10.

31. The method for producing a resin composition according to claim 30, wherein the compound of Formula (4) is represented by Formula (6) 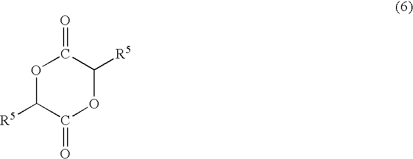
wherein the R⁵s in Formula (6) represent hydrogen atoms or aliphatic hydrocarbon groups having a carbon number ranging from 1 to 18 independent from each other.

32. The method for producing a resin composition according to claim 30, wherein the number-average molecular weight of the polyoxytrimethyleneglycol-based resin (B) is between 400and 500,000.

33. A method for producing a resin composition, comprising mixing a resin composition (C) obtained through the method defined in claim 27 with a polyhydroxycarboxylic-acid-based resin (D) having a structural unit represented by Formula (1) as a main structural unit
—R¹—COO— (1)
wherein R¹ in Formula (1) represents a divalent aliphatic hydrocarbon group.

34. The method for producing a resin composition according to claim 33, wherein:
the structural unit of Formula (1) is represented by Formula (3); and
the number-average molecular weight of the polyhydroxycarboxylic-acid-based resin (D) is between 5,000 and 500,000 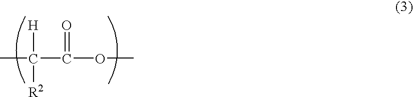
wherein R² in Formula (3) represents a hydrogen atom or an aliphatic hydrocarbon group having a carbon number ranging from 1 to 18.

35. The method for producing a resin composition according to claim 33, wherein a ratio of (C) to the sum of (C) and (D) is between 1 wt % and 70 wt %.

36. A copolymer comprising
a polyhydroxycarboxylic-acid-based block (A′) having a structural unit represented by Formula (1) at 50 wt % or more; and
a polyoxytrimethyleneglycol-based block (B′) having a structural unit represented by Formula (2) at 50 wt % or more
—R¹—COO— (1)
wherein R¹ in Formula (1) represents a divalent aliphatic hydrocarbon groups.

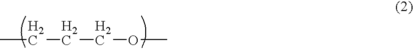

37. The copolymer according to claim 36, wherein the structural unit of Formula (1) is represented by Formula (3) 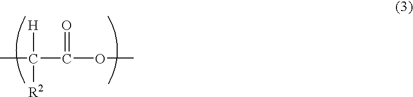
wherein R² in Formula (3) represents a hydrogen atom or an aliphatic hydrocarbon group having a carbon number ranging from 1 to 18.

38. The resin composition according to claim 21, wherein:
the structural unit of Formula (1) is represented by Formula (3); and
the number-average molecular weight of the polyhydroxycarboxylic-acid-based resin (A) is between 5,000 and 500,000. 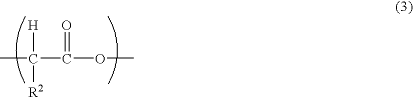
wherein R² in Formula (3) represents a hydrogen atom or an aliphatic hydrocarbon group having a carbon number ranging from 1 to 18.

39. A method for producing a resin composition, comprising mixing a resin composition (C) obtained through the method defined in claim 30 with a polyhydroxycarboxylic-acid-based resin (D) having a structural unit represented by Formula (1) as a main structural unit
—R¹—COO— (1)
wherein R¹ in Formula (1) represents a divalent aliphatic hydrocarbon group.

40. The method for producing a resin composition according to claim 39, wherein:
the structural unit of Formula (1) is represented by Formula (3); and
the number-average molecular weight of the polyhydroxycarboxylic-acid-based resin (D) is between 5,000 and 500,000 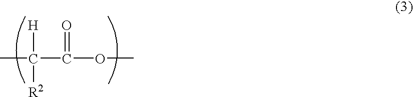
wherein, R² in Formula (3) represents a hydrogen atom or an aliphatic hydrocarbon group having a carbon number ranging from 1 to 18.

41. The method for producing a resin composition according to claim 39, wherein a ratio of (C) to the sum of (C) and (D) is between 1 wt % and 70 wt %.

42. A resin composition produced by the method defined in claim 30.

43. A resin composition produced by the method defined in claim 39.
